(19) United States
(12) Patent Application Publication
(10) Pub. No.: US 2025/0140835 A1
(43) Pub. Date: May 1, 2025

(54) CATHODE ACTIVE MATERIAL POWDER FOR LITHIUM SECONDARY BATTERY, ELECTRODE, AND SOLID LITHIUM SECONDARY BATTERY

(71) Applicant: SUMITOMO CHEMICAL COMPANY, LIMITED, Tokyo (JP)

(72) Inventors: Takuya KADOWAKI, Niihama-shi (JP); Nana ARAI, Niihama-shi (JP)

(21) Appl. No.: 18/835,544

(22) PCT Filed: Feb. 6, 2023
(86) PCT No.: PCT/JP2023/003709

§ 371 Date: Aug. 2, 2024

(30) Foreign Application Priority Data
Feb. 8, 2022 (JP) 2022-018059

(51) Int. Cl. H01M 4/525; H01M 4/02; H01M 4/36; H01M 10/052; H01M 10/0562

(52) U.S. Cl. CPC H01M 4/525; H01M 4/366; H01M 10/052; H01M 10/0562; H01M 2004/021; H01M 2004/028; H01M 2300/0068

(57) ABSTRACT

A cathode active material powder for lithium secondary batteries is provided, containing a core particle consisting of a lithium metal composite oxide, and a coating layer coating at least a part of the core particle, in which the coating layer contains an oxide containing at least one element A selected from the group consisting of Nb, Ta, Ti, Al, B, P, W, Zr, La, and Ge, and the following (1) and (2) are satisfied. (1) a substance amount of the element A per unit area, which is calculated from analysis results by inductively coupled plasma mass spectrometry and a nitrogen adsorption BET method, is 3.0×10⁻⁴ mol/m² or less, and (2) a standard deviation of a compositional ratio of the element A, which is calculated from a value obtained from an SEM-EDX analysis result, is 4.6 or more and 8.2 or less.

### TECHNICAL FIELD

The present invention relates a cathode active material powder for lithium secondary batteries, an electrode, and a solid lithium secondary battery.

Priority is claimed on Japanese Patent Application No. 2022-018059, filed on Feb. 8, 2022, the content of which is incorporated herein by reference.

### BACKGROUND ART

A lithium secondary battery has already been put to practical use not only for small-sized power sources in mobile phone applications, notebook personal computer applications, and the like but also for medium-sized or large-sized power sources in automotive applications, power storage applications, and the like. As the lithium secondary battery, a configuration including a cathode having a cathode active material, an anode, and an electrolyte in contact with the cathode and the anode is known.

As the electrolyte used in the lithium secondary battery, an electrolytic solution containing an organic solvent or a solid electrolyte is known. In the following description, the electrolytic solution and the solid electrolyte may be collectively referred to as “electrolyte”.

At an interface between the cathode and the electrolyte, the cathode active material included in the cathode and the electrolyte are in contact with each other. In the lithium secondary battery, insertion of Li ions from the electrolyte into the cathode active material and extraction of Li ions from the cathode active material into the electrolyte are performed according to charging and discharging of the battery.

Among constituent materials of the cathode active material, a lithium metal composite oxide is closely related to the insertion and extraction of Li ions.

On the other hand, it is known that a side reaction which does not contribute to charging and discharging reactions occurs in a case where the lithium metal composite oxide and the electrolyte are in direct contact with each other and a voltage is applied, and battery characteristics are deteriorated.

As the side reaction, in a case where the electrolyte is an electrolytic solution, oxidative decomposition of the electrolytic solution is an exemplary example. A gas generated by the oxidative decomposition of the electrolytic solution causes battery swelling.

In addition, as the side reaction, in a case where the electrolyte is a solid electrolyte, for example, a reaction in which the solid electrolyte is deteriorated at a portion where the solid electrolyte is in contact with the lithium metal composite oxide and thus a resistance layer is formed is an exemplary example. The resistance layer to be formed inhibits movement of lithium-ions. Here, the “resistance layer” is, for example, a layer having lithium-ion conductivity.

In order to prevent the deterioration of the battery characteristics, in the related art, a method of coating a surface of the lithium metal composite oxide with a coating layer has been studied. For example, Patent Document 1 discloses composite active material particles including a coating layer formed of lithium niobate.

### CITATION LIST

### Patent Document

### [Patent Document 1]

JP-A-2020-53156

### SUMMARY OF INVENTION

### Technical Problem

In a case where the coating layer is provided on the surface of the lithium metal composite oxide as in the related art, the above-mentioned side reactions are less likely to occur. However, a cathode active material including the coating layer has Li-ion conductivity, but has insulation properties, and there is a problem in that it is difficult for electrons to pass through the cathode active materials and a cathode current collector.

The present invention has been made in view of the above circumstances, and an object of the present invention is to provide a cathode active material powder for lithium secondary batteries, including a coating layer, in which Li ions and electrons can smoothly move and a discharge capacity of the lithium secondary battery is less likely to be reduced even in a case where a current density is increased. Another object of the present invention is to provide an electrode and a solid lithium secondary battery, in which the cathode active material powder for lithium secondary batteries is used.

### Solution to Problem

In order to achieve the above-described objects, the present invention includes the following aspects.

[1] A cathode active material powder for lithium secondary batteries, containing:
a core particle consisting of a lithium metal composite oxide; and
a coating layer coating at least a part of the core particle,
in which the coating layer contains an oxide containing at least one element A selected from the group consisting of Nb, Ta, Ti, Al, B, P, W, Zr, La, and Ge, and the following (1) and (2) are satisfied,
(1) a substance amount of the element A per unit area, which is calculated from analysis results by inductively coupled plasma mass spectrometry and a nitrogen adsorption BET method, is 3.0×10⁻⁴ mol/m² or less, and
(2) a standard deviation of a compositional ratio of the element A to a total number of atoms in the cathode active material powder for lithium secondary batteries, which is calculated from a value obtained from an SEM-EDX analysis result, is 4.6 or more and 8.2 or less.

[2] The cathode active material powder for lithium secondary batteries according to [1],
in which the cathode active material powder is used by being brought into contact with a solid electrolyte.

[3] The cathode active material powder for lithium secondary batteries according to [2],
in which the cathode active material powder is used by being brought into contact with a sulfide solid electrolyte.

[4] The cathode active material powder for lithium secondary batteries according to any one of [1] to [3],
in which a surface presence rate of the element A, which is calculated from an XPS analysis result of the cathode active material powder for lithium secondary batteries, is 50% or more.

[5] The cathode active material powder for lithium secondary batteries according to any one of [1] to [4],
in which the element A is Nb or P.

[6] The cathode active material powder for lithium secondary batteries according to any one of [1] to [5],
in which the cathode active material powder has a layered crystal structure.

[7] The cathode active material powder for lithium secondary batteries according to any one of [1] to [6],
in which the following compositional formula (I) is satisfied,

Li[Liₓ(Ni_{(1-y-z-w)}Co_{y}Mn_{z}M_{w})₁₋ₓ]O₂ (I)
(where M is at least one element selected from the group consisting of Fe, Cu, Mg, Al, W, B, P, Mo, Zn, Sn, Zr, Ga, La, Ti, Nb, and V, and −0.10≤x≤0.30, 0≤y≤0.40, 0≤z≤0.40, and 0<w≤0.10 are satisfied).

[8] The cathode active material powder for lithium secondary batteries according to [7],
in which, in the compositional formula (I), 0.50≤1−y−z−w≤0.95 and 0≤y≤0.30 are satisfied.

[9] An electrode containing:
the cathode active material powder for lithium secondary batteries according to any one of [1] to [8].

[10] The electrode according to [9], further containing:
a solid electrolyte.

[11] A solid lithium secondary battery, including:
a cathode;
an anode; and
a solid electrolyte layer interposed between the cathode and the anode,
wherein the solid electrolyte layer contains a first solid electrolyte,
the cathode includes a cathode active material layer in contact with the solid electrolyte layer, and a current collector on which the cathode active material layer is laminated, and
the cathode active material layer contains the cathode active material powder for lithium secondary batteries according to any one of [1] to [8].

[12] The solid lithium secondary battery according to [11],
in which the cathode active material layer further contains a second solid electrolyte.

[13] The solid lithium secondary battery according to [12],
in which the first solid electrolyte and the second solid electrolyte are the same material.

[14] The solid lithium secondary battery according to any one of [11] to [13],
in which the first solid electrolyte is a sulfide solid electrolyte.

### Advantageous Effects of Invention

According to the present invention, it is possible to provide a cathode active material powder for lithium secondary batteries, including a coating layer, in which, at an interface with an electrolyte, Li ions and electrons can smoothly move and a discharge capacity of the lithium secondary battery is less likely to be reduced even in a case where a current density is increased. In addition, it is possible to provide an electrode and a solid lithium secondary battery, in which the cathode active material powder for lithium secondary batteries is used.

### BRIEF DESCRIPTION OF DRAWINGS

FIG. 1 is a schematic view showing an example of a lithium secondary battery.

FIG. 2 is a schematic view showing an example of a solid lithium secondary battery.

### DESCRIPTION OF EMBODIMENTS

### <Cathode Active Material Powder for Lithium Secondary Batteries>

The present embodiment is a cathode active material powder for lithium secondary batteries, containing a core particle consisting of a lithium metal composite oxide, and a coating layer coating at least a part of the core particle.

In the present specification, a metal composite compound will be referred to as “MCC”.

A lithium metal composite oxide will be referred to as “LiMO”.

A cathode active material for lithium secondary batteries powder will be referred to as “CAM”.

The notation “Li” does not indicate a Li metal element, but a Li element, unless particularly otherwise specified. The same applies to notations of other elements such as Ni, Co, and Mn.

In a case where a numerical range is described as, for example, “1 to 10 μm”, the numerical range means a range from 1 μm to 10 μm, and means a numerical range including 1 μm as a lower limit value and 10 μm as an upper limit value.

The CAM according to the present embodiment contains a coating layer containing a specific element A, and satisfies (1) and (2).
(1) a substance amount of the element A per unit area, which is calculated from a value obtained by inductively coupled plasma mass spectrometry and a nitrogen adsorption BET method, is 3.0×10⁻⁴ mol/m² or less.
(2) a standard deviation of a compositional ratio of the element A to a total number of atoms in the CAM, which is calculated from a value obtained from an SEM-EDX analysis result, is 4.6 to 8.2.

Various methods for coating a surface of the LiMO with a coating layer have been studied, but in the studies of the related art, for example, a film thickness of the coating layer has been focused on. However, the molecular weight and true density of the coating layer are different even in a case where coating layers have the same film thickness, depending on the type of elements constituting the coating layer or the type of compounds constituting the coating layer. Therefore, in a case where only the film thickness of the coating layer is controlled, the coating layer is insufficient at protecting the core particles from the viewpoint of the same film thickness but different densities.

In addition, as a known method for measuring the film thickness of the coating layer, there is, for example, a method of locally observing an arbitrary location by TEM analysis, or a method of calculating the film thickness from the amount of the contained elements obtained by inductively coupled plasma-atomic emission spectroscopy, assuming that the density of the coating layer is a certain value. However, in these methods, the accuracy is insufficient in a case of measuring the film thickness as a representative value of the powder of the LiMO.

As a result of the studies by the present inventors, it was found that, by controlling the substance amount of the element A constituting the coating layer to 3.0×10⁻⁴ mol/m² or less, the coating layer can function as a protective layer while suppressing an increase in resistance, regardless of the type of elements constituting the coating layer or the type of compounds constituting the coating layer.

The CAM satisfying (1) indicates that the coating layer as a thin film containing the element A is formed on the surface of the core particle. Therefore, in the lithium secondary battery using the CAM, the core particles are protected by the coating layer, and the resistance layer is unlikely to be formed inside the battery even in a case where any element is selected as the element A, and even in a case where charging and discharging are repeated in a state of being in contact with the electrolyte. Furthermore, since the coating layer is a thin film, the Li ions are likely to smoothly move, and the discharge capacity of the lithium secondary battery is less likely to be reduced.

The CAM according to the present embodiment satisfies (2) in addition to (1). The standard deviation of the compositional ratio of the element A in (2) corresponds to a thickness variation of the coating layer formed on the surface of the core particle.

In general, it is considered that, as the standard deviation of the compositional ratio of the element A becomes smaller, the thickness variation becomes smaller, which is preferable.

However, the present inventors found that, in a case where the standard deviation of the compositional ratio of the element A has a specific variation, the discharge capacity of the lithium secondary battery is less likely to be reduced.

The mechanism of the action effect has not been clarified at the present time, but the present inventors have presumed as follows.

The fact that the standard deviation of the compositional ratio of the element A is 4.6 or more means that the coating layer has a thick film portion and a thin film portion. In the thin film portion, since a potential barrier is lower than that in the thick film portion, electrons are concentrated in the thin film portion, and thus a tunnel current is likely to occur. As a result, it is considered that the electrons are likely to move smoothly and the discharge capacity is less likely to be reduced.

On the other hand, in a case where the standard deviation is less than 4.6, the film thickness of the coating layer is to be uniform, so that the concentration of the electrons is less likely to occur, and the tunnel current is also less likely to occur. As a result, it is considered that the smooth movement of the electrons is impaired, and the discharge capacity of the lithium secondary battery is less likely to be reduced.

In a case where the CAM satisfying (1) and (2) is charged and discharged at a high current density (for example, 10 C), the Li ions are easily moved on the surface of the CAM, and hindering of the movement of the Li ions is less likely to occur. Therefore, the discharge capacity is less likely to be reduced even in a case where the charging and discharging are performed at a high current density.

A description will be given below in order.

The CAM has a layered crystal structure and contains at least Li and a transition metal. It is preferable that the LiMO, which is the core particle of the CAM, have a layered crystal structure and include at least Li and a transition metal.

The CAM contains, as the transition metal, at least one selected from the group consisting of Ni, Co, Mn, Fe, Cu, Mg, Al, W, B, P, Mo, Zn, Sn, Zr, Ga, La, Ti, Nb, and V. It is desirable that the LiMO, which is the core particle of the CAM, include, as the transition metal, at least one selected from the group consisting of Ni, Co, Mn, Fe, Cu, Mg, Al, W, B, P, Mo, Zn, Sn, Zr, Ga, La, Ti, Nb, and V.

In a case where the CAM contains the above-described element as the transition metal, the obtained CAM forms a stable crystal structure from which the Li ions can be easily removed and inserted.

More specifically, the CAM is represented by the following compositional formula (I).

Li[Liₓ(Ni_{(1-y-z-w)}Co_{y}Mn_{z}M_{w})₁₋ₓ]O₂ (I)
(where, M is at least one element selected from the group consisting of Fe, Cu, Mg, Al, W, B, P, Mo, Zn, Sn, Zr, Ga, La, Ti, Nb, and V, and −0.10≤x≤0.30, 0≤y≤0.40, 0≤z≤0.40, and 0<w≤0.10 are satisfied)

### (Regarding x)

From the viewpoint of obtaining a lithium-ion secondary battery having favorable cycle characteristics, x in the compositional formula (I) is preferably more than 0, more preferably 0.01 or more, and still more preferably 0.02 or more. In addition, from the viewpoint of obtaining a lithium secondary battery having a higher initial charge and discharge efficiency, x in the compositional formula (I) is preferably 0.25 or less, and more preferably 0.10 or less.

In the present specification, “favorable cycle characteristics” means that a decrease in capacity of the battery due to the repetition of charging and discharging is small, and a capacity ratio in re-measurement with respect to the initial capacity is unlikely to decrease.

In addition, in the present specification, the “initial charge and discharge efficiency” is a value obtained by “(Initial discharge capacity)/(Initial charge capacity)×100(%)”. The secondary battery having a high initial charge and discharge efficiency has a small irreversible capacity during the first charging and discharging, and is likely to have a larger capacity per volume and weight.

The upper limit value and lower limit value of x can be randomly combined together. In the compositional formula (I), x may be −0.10 to 0.25, or −0.10 to 0.10.

x may be more than 0 and 0.30 or less, more than 0 and 0.25 or less, or more than 0 and 0.10 or less.

x may be 0.01 to 0.30, 0.01 to 0.25, or 0.01 to 0.10.

x may be 0.02 to 0.3, 0.02 to 0.25, or 0.02 to 0.10.

It is preferable that x satisfy 0<x≤0.30.

### (Regarding y)

In addition, from the viewpoint of obtaining a lithium-ion secondary battery having low internal resistance, y in the compositional formula (I) is preferably more than 0, more preferably 0.005 or more, still more preferably 0.01 or more, and particularly preferably 0.05 or more. In addition, from the viewpoint of obtaining a lithium secondary battery having high thermal stability, y in the compositional formula (I) is more preferably 0.35 or less, still more preferably 0.33 or less, and even more preferably 0.30 or less.

The upper limit value and lower limit value of y can be randomly combined together. In the compositional formula (I), y may be 0 to 0.35, 0 to 0.33, or 0 to 0.30.

y may be more than 0 and 0.40 or less, more than 0 and 0.35 or less, more than 0 and 0.33 or less, or more than 0 and 0.30 or less.

y may be 0.005 to 0.40, 0.005 to 0.35, 0.005 to 0.33, or 0.005 to 0.30.

y may be 0.01 to 0.40, 0.01 to 0.35, 0.01 to 0.33, or 0.01 to 0.30.

y may be 0.05 to 0.40, 0.05 to 0.35, 0.05 to 0.33, or 0.05 to 0.30.

It is preferable that y satisfy 0<y≤0.40.

In the compositional formula (I), it is more preferable that 0<x≤0.10 and 0≤y≤0.40.

### (Regarding z)

In addition, from the viewpoint of obtaining a lithium secondary battery having favorable cycle characteristics, z in the compositional formula (I) is preferably more than 0, more preferably 0.01 or more, still more preferably 0.02 or more, and particularly preferably 0.1 or more. In addition, from the viewpoint of obtaining a lithium secondary battery having high storage stability at a high temperature (for example, under an environment of 60° C.), z in the compositional formula (I) is preferably 0.39 or less, more preferably 0.38 or less, and still more preferably 0.35 or less.

The upper limit value and lower limit value of z can be randomly combined together. In the compositional formula (I), z may be 0 to 0.39, 0 to 0.38, or 0 to 0.35.

z may be 0.01 to 0.40, 0.01 to 0.39, 0.01 to 0.38, or 0.01 to 0.35.

z may be 0.02 to 0.40, 0.02 to 0.39, 0.02 to 0.38, or 0.02 to 0.35.

z may be 0.10 to 0.40, 0.10 to 0.39, 0.10 to 0.38, or 0.10 to 0.35.

### (Regarding w)

In addition, from the viewpoint of obtaining a lithium secondary battery having low internal resistance, w in the compositional formula (I) is preferably more than 0, more preferably 0.0005 or more, and still more preferably 0.001 or more. In addition, from the viewpoint of obtaining a lithium secondary battery having a large discharge capacity at a high current rate, w in the compositional formula (I) is preferably 0.09 or less, more preferably 0.08 or less, and still more preferably 0.07 or less.

The upper limit value and lower limit value of w can be randomly combined together. In the compositional formula (I), w may be more than 0 and 0.10 or less, more than 0 and 0.09 or less, more than 0 and 0.08 or less, or more than 0 and 0.07 or less.

w may be 0.0005 to 0.10, 0.0005 to 0.09, 0.0005 to 0.08, or 0.0005 to 0.07.

w may be 0.001 to 0.10, 0.001 to 0.09, 0.001 to 0.08, or 0.001 to 0.07.

(Regarding y+z+w)

In addition, from the viewpoint of obtaining a lithium secondary battery having a large battery capacity, y+z+w in the compositional formula (1) is preferably 0.50 or less, more preferably 0.48 or less, and still more preferably 0.46 or less.

With regard to the CAM, it is preferable that, in the compositional formula (I), 0.50≤1−y−z−w≤0.95 and 0≤y≤0.30. That is, it is preferable that the CAM have a Ni content molar ratio of 0.50 or more and a Co content molar ratio of 0.30 or less in the compositional formula (I).

### (Regarding M)

M in the compositional formula (I) represents one or more elements selected from the group consisting of Fe, Cu, Mg, Al, W, B, P, Mo, Zn, Sn, Zr, Ga, La, Ti, Nb, and V.

In addition, from the viewpoint of obtaining a lithium secondary battery having high cycle characteristics, M in the compositional formula (I) is preferably one or more elements selected from the group consisting of Mg, Al, W, B, and Zr; and more preferably one or more elements selected from the group consisting of Al and Zr. In addition, from the viewpoint of obtaining a lithium secondary battery having high thermal and electrical stability, M is preferably one or more elements selected from the group consisting of Nb, Ta, Ti, Al, B, P, W, and Zr.

An example of a preferred combination of x, y, z, and w described above is one in which x is 0.02 to 0.3, y is 0.05 to 0.30, z is 0.02 to 0.35, and w is more than 0 and 0.07 or less.

As the CAM having a preferred combination of x, y, z, and w, for example, the CAM in which x=0.05, y=0.20, z=0.30, and w=0.01; the CAM in which x=0.05, y=0.08, z=0.04, and w=0.01; and the CAM in which x=0.25, y=0.07, z=0.02, and w=0.01 are exemplary examples.

In a case where the element A constituting the coating layer and the transition metal element constituting the LiMO, which is the core particle, overlap, the overlapping element is treated as the element constituting the coating layer.

### [Composition Analysis]

A composition of the CAM can be analyzed using an inductively coupled plasma emission (ICP) spectrometer (for example, SPS3000 manufactured by Seiko Instruments Inc.) after the CAM is dissolved in hydrochloric acid.

### (Crystal Structure)

The CAM has a layered crystal structure. The crystal structure of the CAM is more preferably a hexagonal crystal structure or a monoclinic crystal structure.

The hexagonal crystal structure belongs to any one space group selected from the group consisting of P3, P3₁, P3₂, R3, P-3, R-3, P312, P321, P3₁12, P3₁21, P3₂12, P3₂21, R32, P3 m1, P31m, P3c1, P31c, R3m, R3c, P-31m, P-31c, P-3 m1, P-3cd, R-3m, R-3c, P6, P6₁, P6₅, P6₂, P6₄, P6₃, P-6, P6/m, P63/m, P622, P6₁22, P6₅22, P6₂22, P6₄22, P6₃22, P6 mm, P6cc, P6₃cm, P6₃mc, P-6m2, P-6c2, P-62m, P-62c, P6/mmm, P6/mcc, P63/mcm, and P63/mmc.

In addition, the monoclinic crystal structure belongs to any one space group selected from the group consisting of P2, P2₁, C2, Pm, Pc, Cm, Cc, P2/m, P2₁/m, C2/m, P2/c, P21/c, and C2/c.

Among these, in order to obtain a lithium secondary battery having a high discharge capacity, the crystal structure is particularly preferably a hexagonal crystal structure belonging to the space group R-3m or a monoclinic crystal structure belonging to the space group C2/m.

### [Crystal Structure Analysis]

The crystal structure of the CAM can be analyzed by X-ray diffraction measurement.

Specifically, the X-ray diffraction measurement of the CAM is performed using an X-ray diffractometer (for example, X'Pert PRO, Malvern Panalytical Ltd).

The CAM is loaded into a dedicated substrate, and a powder X-ray diffraction pattern is obtained by measuring the CAM under the conditions of a diffraction angle 2θ=10° to 90°, a sampling width of 0.02°, and a scanning speed of 4°/min using CuKα radiation.

By confirming whether or not the obtained X-ray analysis pattern belongs to the known X-ray diffraction pattern of the layered crystal structure, it is possible to confirm whether or not the CAM has the layered crystal structure.

The coating layer of the CAM contains an oxide containing at least one element A selected from the group consisting of Nb, Ta, Ti, Al, B, P, W, Zr, La, and Ge.

### [SEM-EDX Measurement]

The fact that the coating layer contains the element A and the fact that the coating layer contains the oxide containing the element A can be confirmed by analysis using a scanning electron microscope (SEM)-energy dispersive X-ray spectroscopy (EDX). Hereinafter, the scanning electron microscope-energy dispersive X-ray spectroscopy may be referred to as SEM-EDX. As a scanning electron microscope-energy dispersive X-ray spectrometer, for example, a Schottky field emission scanning electron microscope (manufactured by JEOL Ltd., product name: JSM-7900F) equipped with X-Max 150 and Ultim Extreme of Oxford Instruments as an EDX detector can be used.

Specifically, the particles of the CAM are placed on a carbon double-sided tape, and SEM observation (imaging of a reflection electron image) is performed.

At this time, in a case where the measurement of at least one element selected from the group consisting of B is targeted, the SEM observation (imaging of a reflection electron image) is performed by irradiating the sample with an electron beam having an acceleration voltage of 1.1 kV.

In addition, in a case where the measurement of at least one element selected from the group consisting of Nb, Ta, Al, P, W, Zr, and Ge is targeted, the SEM observation (imaging of a reflection electron image) is performed by irradiating the sample with an electron beam having an acceleration voltage of 3 kV.

In addition, in a case where the measurement of at least one element selected from the group consisting of Ti and La is targeted, the SEM observation (imaging of a reflection electron image) is performed by irradiating the sample with an electron beam having an acceleration voltage of 10 kV.

Subsequently, an EDX analysis of the particle surface is performed in the same field of view as the range observed by the SEM. The surface referred to herein is intended to have an information depth of 1 μm or less, and in order to realize the composition analysis at this information depth, it is preferable to measure the surface with an acceleration voltage of 10 kV or less, and it is more preferable to measure the surface with an acceleration voltage of 3 kV or less. A characteristic X-ray is generated from each particle included in the field of view by electron beam excitation, thereby obtaining an X-ray spectrum including the characteristic X-ray of a plurality of elements included in the measurement position. The number (count number, intensity) of the characteristic X-ray of each element included in the measured spectrum corresponds to the concentration of each element.

In a case of quantifying the concentration, a sensitivity coefficient obtained by Oxford Instruments at the time of factory shipment by measurement at an acceleration voltage of 5 kV, with a standard sample spectrum, is used.

As a forming material of such a coating layer, it is preferable to use, as a main component, at least one oxide selected from the group consisting of Nb₂O₅, Ta₂O₅, TiO₂, Al₂O₃, WO₃, B₂O₃, ZrO₃, P₂O₅, La₂O₃, GeO₂, LiNbO₃, LiTaO₃, Li₂TiO₃, LiAlO₂, Li₂WO₄, Li₄WO₅, Li₃BO₃, Li₄B₂O₇, Li₃PO₄, Li₇La₃Zr₂O₁₂ (LLZ), Li₅La₃Ta₂O₁₂ (LLT), Li_{1.5}Al_{0.5}Ge_{1.5}P₃O₁₂ (LAGP), and Li_{1.3}Al_{0.3}Ti_{1.7}P₃O₁₂ (LATP).

As a combination of a case in which the coating layer contains two or more kinds of the above-described oxides, for example, a combination of Nb₂O₅ and P₂O₅ and a combination of LiNbO₃ and Li₃PO₄ are exemplary examples.

The “using as the main component” the above-described oxide for the forming material of the coating layer means that the content of the above-described oxide is the highest among forming materials of the coating layer. The content of the above-described oxide with respect to the entire coating layer is preferably 50 mol % or more, and more preferably 60 mol % or more. In addition, the content of the above-described oxide with respect to the entire coating layer is preferably 90 mol % or less.

(1)

### [Method for Obtaining Substance Amount of Element A]

The substance amount (mol/m²) of the element A per unit area in the CAM is calculated by the following expression.

Substance amount of element A per unit area in CAM (mol/m²)=ICP mass analysis rate (g/gₐₗₗ)/Molecular weight (g/mol)/BET specific surface area (m²/gₐₗₗ) The ICP mass analysis rate (g/gₐₗₗ) is a mass proportion of the element A with respect to the total amount (gₐₗₗ) of elements contained in the CAM. The ICP mass analysis rate (g/gₐₗₗ) is obtained by inductively coupled plasma mass spectrometry of the CAM.

The molecular weight (g/mol) is a molecular weight calculated from the compositional formula of the CAM.

The BET specific surface area (cm²/gₐₗₗ) is a specific surface area of the CAM obtained by the nitrogen adsorption BET method.

The ICP mass analysis and the molecular weight are obtained by the methods described in [Composition analysis] above.

### (Measurement of BET Specific Surface Area)

The BET specific surface area (cm²/gₐₗₗ) is calculated by the nitrogen adsorption BET method using a specific surface area measuring device. As the specific surface area measuring device, for example, a specific surface area/pore size distribution measuring device BELSORP MINI II manufactured by MicrotracBEL Corp. can be used.

The particles of the CAM for measuring the substance amount of the element A per unit area include particles having a 50% cumulative volume-based particle size D50 (μm)±20%, which is obtained by a laser diffraction type particle size distribution measurement.

The substance amount of the element A per unit area satisfies 3.0×10⁻⁴ mol/m² or less, preferably satisfies 2.8×10⁻⁴ mol/m² or less and more preferably satisfies 2.6×10⁻⁴ mol/m² or less.

In addition, as the substance amount of the element A per unit area, for example, 0.5×10⁻⁴ mol/m² or more, 0.6×10⁻⁴ mol/m² or more, and 0.7×10⁻⁴ mol/m² or more are exemplary examples.

The above-described upper limit value and lower limit value of the substance amount of the element A can be randomly combined together.

As an example of the combination, for example, 0.5×10⁻⁴ to 3.0×10⁻⁴ mol/m², 0.6×10⁻⁴ to 2.8×10⁻⁴ mol/m², and 0.8×10⁻⁴ to 2.6×10⁻⁴ mol/m² are exemplary examples.

In a case where the electrolyte is an electrolytic solution, since the coating layer can act as a protective film of the core particles, the side reaction which occurs in a case where the electrolytic solution and the core particles are in direct contact with each other can be reduced.

In a case where the electrolyte is a solid electrolyte, the resistance layer may be formed at the interface in a case where the solid electrolyte and the CAM are in direct contact with each other to charge and discharge. Since the coating layer can act as a protective film of the core particles, the resistance layer is unlikely to be formed.

In a case where the core particles are protected by the coating layer, and the above-described side reaction is reduced or the resistance layer is unlikely to be formed, the discharge capacity is easily maintained even in a case where the charging and discharging of the lithium secondary battery are repeated.

(2)

In the CAM, the standard deviation of the compositional ratio of the element A to the total number of atoms in the CAM, which is calculated from a value obtained from an SEM-EDX analysis result, satisfies 4.6 to 8.2. The description of the SEM-EDX analysis is the same as that described above. The standard deviation of the compositional ratio of the element A to the total number of atoms in the CAM preferably satisfies 4.8 to 7.0.

The above-described standard deviation is a standard deviation between the particles of the CAM in a case where the compositional ratio of the element A to the total number of atoms in the CAM is obtained for each of the particles of the plurality of CAMs.

In the present embodiment, the compositional ratio of the element A with respect to the total number of atoms in the CAM is obtained for each of 50 particles, and the standard deviation between the particles of the CAM is obtained.

As a method of selecting the 50 particles, a median diameter (D50) obtained by a particle size distribution measuring device is used as a reference, and the 50 particles are randomly selected from a range of the median diameter±20%.

(3)

It is preferable that the surface presence rate of the element A, obtained from the XPS analysis result of the CAM, satisfy 50% or more. In a case where the surface presence rate of the element A satisfies 50% or more, it is determined that the coating layer is present on the surface of the core particle at a high surface presence rate.

The surface presence rate of the element A is more preferably 55% or more, and still more preferably 60% or more.

The surface presence rate of the element A is, for example, 100% or less, 99% or less, or 98% or less.

The above-described upper limit value and lower limit value of the surface presence rate of the element A can be randomly combined together. The surface presence rate of the element A is, for example, 50% to 100%, 55% to 99%, or 60% to 98%.

### [Method for Measuring Surface Presence Rate of Element A]

Since the element A is present in the coating layer of the CAM, in a case where the XPS analysis is performed on the CAM, photoelectrons corresponding to the kinetic energy of the element A present in the coating layer are detected.

The surface presence rate of the element A in the CAM is determined based on the analysis result using XPS.

Specifically, surface composition analysis of the CAM is performed under the following conditions to obtain a narrow scan spectrum on the surface of the CAM.
Measurement method: X-ray photoelectron spectroscopy (XPS)
X-ray radiation source: AlKα radiation (1486.6 eV)
X-ray spot diameter: 100 μm
Neutralization conditions: neutralization electron gun (acceleration voltage is adjusted depending on the element; current: 100 μA)

A detection depth of the XPS under the above-described conditions is in a range of approximately 3 nm from the surface of the CAM to the inside. In the CAM, in a portion where the coating layer is thinner than the above-described detection depth or the coating layer is not provided, the surface of the core particle is analyzed in addition to the coating layer.

The peak corresponding to each element can be identified using an existing database.

As a photoelectron intensity of Nb as the element A, an integrated value of a waveform of Nb3d is used.

As a photoelectron intensity of Ta as the element A, an integrated value of a waveform of Ta4f is used.

As a photoelectron intensity of Ti as the element A, an integrated value of a waveform of Ti2p is used.

As a photoelectron intensity of Al as the element A, an integrated value of a waveform of Al2p is used.

As a photoelectron intensity of B as the element A, an integrated value of a waveform of Bis is used.

As a photoelectron intensity of P as the element A, an integrated value of a waveform of P2p is used.

As a photoelectron intensity of W as the element A, an integrated value of a waveform of W4f is used. However, in a case of being measured at the same time as Ge, an integrated value of a background of W4d is used.

As a photoelectron intensity of Zr as the element A, an integrated value of a waveform of Zr3d is used.

As a photoelectron intensity of La as the element A, an integrated value of a waveform of La3d5/2 is used.

As a photoelectron intensity of Ge as the element A, an integrated value of a waveform of Ge2p is used.

In addition, in the same XPS analysis, photoelectrons corresponding to the kinetic energy of each element are also detected for the transition metal contained in the LiMO.

As the transition metal contained in the LiMO, for example, an integrated value of a waveform of Ni2p3/2 is used as a photoelectron intensity of Ni.

As the transition metal contained in the LiMO, an integrated value of a waveform of Co2p3/2 is used as a photoelectron intensity of Co.

As the transition metal contained in the LiMO, an integrated value of a waveform of Mn2p1/2 is used as a photoelectron intensity of Mn.

The ratio of the photoelectron intensity of each element in the obtained spectrum corresponds to the element ratio of the CAM obtained by the XPS measurement.

The CAM contains the element A in an aspect in which a proportion (α/(α+β))×100 of “Photoelectron intensity α of element A” to the total of “Photoelectron intensity α of element A” and “Photoelectron intensity β of transition metal contained in LiMO and element A”, which are obtained from the XPS analysis result of the coating layer measured by the above-described method, satisfies 50% or more.

In the CAM to be measured, there is a case in which an element common to the coating layer and the LiMO is contained. In this case, the above-described element ratio in the XPS analysis result is handled without distinguishing whether the element is an element contained in the coating layer or an element contained in the LiMO.

For example, in a case where Ti is contained in both the coating layer and the LiMO, the element ratio of Ti obtained as the XPS analysis result is handled as the total element ratio of Ti contained in the LiMO and Ti contained in the coating layer. From the composition of the LiMO, since the Ti contained in the LiMO is originally small, the elemental ratio of Ti obtained as the XPS analysis result can be regarded as the elemental ratio of Ti present in the coating layer.

The CAM satisfying (1), (2), and (3) is a CAM including a coating layer with a high surface presence rate; and the Li ions and electrons are likely to move on the surface of the CAM, and hindering of the movement of the Li ions and the electrons is less likely to occur. Therefore, the discharge capacity is less likely to be reduced even in a case where the charging and discharging are repeated at a high rate. Therefore, for example, a lithium secondary battery having a high discharge capacity at a high rate can be provided.

The battery performance of the solid lithium-ion secondary battery can be evaluated by an initial charge and discharge efficiency obtained by the following method.

### [Measurement of Initial Charge and Discharge Efficiency]

<Manufacturing of all-Solid Lithium-Ion Secondary Battery>

The following operation is carried out in a glove box under an argon atmosphere.

### (Production of Cathode Mixture)

1,000 mg of the cathode active material obtained by the above-described method, 0.0543 g of a conductive material (Acetylene Black), and 8.6 mg of a solid electrolyte (manufactured by MSE CO., LTD., Li₆PS₅Cl) are weighed. The cathode active material, the conductive material, and the solid electrolyte are mixed in a mortar for 15 minutes to produce a cathode mixture.

### (Production of Battery Cell)

Next, 150 mg of the solid electrolyte (manufactured by MSE CO., LTD., Li₆PS₅Cl) is charged into a battery cell for an all-solid battery (HSSC-05 manufactured by Hohsen Corp.; electrode size: φ10 mm), and the cell is pressurized to a load of 29.3 kN with a uniaxial press machine to form a solid electrolyte layer.

Next, the pressure is released, and the upper punch is pulled out, and 14.4 mg of the above-described cathode mixture is put on the solid electrolyte layer molded in the cell. An SUS foil (φ10 mm×0.5 mm thick) is inserted thereon, and the upper punch is inserted again and pushed in by hand.

The all-solid battery cell is turned upside down, a punch on the side of the cathode mixture is pulled out, and a lithium metal foil (thickness: 50 μm) and an indium foil (thickness: 100 μm) punched out with a diameter of φ8.5 mm are sequentially inserted on the solid electrolyte layer as an anode.

Furthermore, an SUS foil having a diameter of φ10 mm and a thickness of 50 μm is inserted on the anode, a punch of the battery cell is inserted, and the cell is pressurized up to a load of 512 kN with a uniaxial press, and after the pressure is released, a screw of the case is tightened so that the internal restraint pressure of the cell is set to 200 MPa.

A glass desiccator in which an electrical wiring is connected inside and outside while having confidentiality is prepared, the above-described battery cell is put into the glass desiccator, each electrode of the cell and the wiring of the desiccator are connected, and the glass desiccator is sealed to produce a sulfide-based all-solid lithium-ion secondary battery. The completed sulfide-based all-solid lithium-ion secondary battery is taken out from the argon atmosphere glove box, and the following evaluation is performed.

### <Charging and Discharging Test>

Using the all-solid battery produced by the above-described method, a charging and discharging test is carried out under the following conditions.

### (Charging and Discharging Conditions)

Test temperature: 60° C.

### (First Charging and Discharging (Initial))

Charging maximum voltage: 3.68 V; Charging current density: 0.1 CA, Cutoff current density: 0.02 C; Constant current-constant voltage charging
Discharging minimum voltage: 1.88 V; Discharging current density: 0.1 CA; Constant current discharging

### (Second Charging and Discharging)

Charging maximum voltage: 3.68 V; Charging current density: 0.1 CA, Cutoff current density: 0.02 C; Constant current-constant voltage charging
Discharging minimum voltage: 1.88 V; Discharging current density: 0.1 CA; Constant current discharging

### (Rate Test)

Charging maximum voltage: 3.68 V; Charging current density: 0.5 CA, Cutoff current density: 0.02 C; Constant current-constant voltage charging
Discharging minimum voltage: 1.88 V; Discharging current density: 0.2 CA, 0.5 CA, 1 CA, 2 CA, 3 CA, and 5 CA; Constant current discharge (in order of each discharge current density)

The current density of 1 C is an initial charge capacity in the liquid lithium-ion battery evaluation, which will be described later.

A 5 CA/0.1 CA discharge capacity ratio obtained is obtained by the following expression using the discharge capacity in the second time of the constant current discharging at 0.1 CA and the discharge capacity in the constant current discharging at 5 CA (eighth time of discharging), and is used as an indicator of the discharge rate characteristic.

### (5 CA/0.1 CA Discharge Capacity Ratio)

$$5 CA / 0.1 CA Discharge capacity ratio ( \% ) = Discharge capacity in 5 CA ( eighth time of discharging ) / Discharge capacity in 0.1 CA ( second time of discharge ) \times 100$$

In a case where the 5 CA/0.1 CA discharge capacity ratio (%) is 10% or more, it is evaluated that the discharge capacity is less likely to be reduced.

### <Manufacturing of Liquid-Type Lithium Secondary Battery>

### (Production of Cathode for Lithium Secondary Batteries)

The CAM obtained by a manufacturing method described later, a conductive material (Acetylene Black), and a binder (PVdF) are added and kneaded in a proportion of CAM:conductive material:binder=92:5:3 (mass ratio) to prepare a paste-like cathode material mixture. During the preparation of the cathode material mixture, N-methyl-2-pyrrolidone is used as an organic solvent.

The obtained cathode material mixture is applied to an Al foil having a thickness of 40 μm, which serves as a current collector, and dried in a vacuum at 150° C. for 8 hours, thereby obtaining a cathode for lithium secondary batteries. The electrode area of the cathode for lithium secondary batteries is set to 1.65 cm².

### (Production of Lithium Secondary Battery (Coin-Type Half-Cell))

The following operation is carried out in a glove box under an argon atmosphere.

The cathode for lithium secondary batteries, produced in (Production of cathode for lithium secondary batteries), is placed on the lower lid of a part for a coin-type battery R2032 (manufactured by Hohsen Corp.) with the aluminum foil surface facing downward, and a separator (polyethylene porous film) is placed thereon.

300 μl of an electrolytic solution is injected therein. As the electrolytic solution, a solution obtained by dissolving LiPF₆ in a mixed solution of ethylene carbonate, dimethyl carbonate, and ethyl methyl carbonate at a volume ratio of 30:35:35 with a proportion of 1.0 mol/1 is used.

Next, lithium metal is used as an anode, and the anode is placed on the upper side of the laminated film separator. An upper lid is placed through a gasket and caulked using a caulking machine, thereby producing a lithium secondary battery (coin-type half-cell CR2032; hereinafter, may be referred to as “half-cell”).

### <Charging and Discharging Test>

Using the liquid-type lithium secondary battery produced by the above-described method, a charging and discharging test is carried out under the following conditions.

### (Charging and Discharging Conditions)

Test temperature: 25° C.

### (First Charging and Discharging (Initial))

Charging maximum voltage: 4.3 V; Charging current density: 0.2 CA, Cutoff current density: 0.05 C; Constant current-constant voltage charging
Discharging minimum voltage: 2.5 V; Discharging current density: 0.2 CA; Constant current discharging

### (Second Charging and Discharging)

Charging maximum voltage: 4.3 V; Charging current density: 0.2 CA, Cutoff current density: 0.05 C; Constant current-constant voltage charging
Discharging minimum voltage: 2.5 V; Discharging current density: 0.2 CA; Constant current discharging

### (Rate Test)

Charging maximum voltage: 4.3 V; Charging current density: 1.0 CA, Cutoff current density: 0.05 C; Constant current-constant voltage charging
Discharging minimum voltage: 2.5 V; Discharging current density: 0.5 CA, 1 CA, 2 CA, 5 CA, and 10 CA; Constant current discharge; the following tests are carried out in order of each discharge current density.

A 10 CA/0.2 CA discharge capacity ratio obtained is obtained by the following expression using the discharge capacity in the second time of the constant current discharging at 0.2 CA and the discharge capacity in the constant current discharging at 10 CA (seventh time of discharging), and is used as an indicator of the discharge rate characteristic.

### (10 CA/0.2 CA Discharge Capacity Ratio)

$$10 CA / 0.2 CA Discharge capacity ratio ( \% ) = Discharge capacity in 10 CA ( seventh time of discharging ) / Discharge capacity in 0.2 CA ( second time of discharging ) \times 100$$

In a case where the 10 CA/0.2 CA discharge capacity ratio (%) is 70% or more, it is evaluated that the discharge capacity is less likely to be reduced.

### <Method for Manufacturing Cathode Active Material for Lithium Secondary Batteries>

A method for manufacturing the CAM according to the present embodiment includes a step of manufacturing the LiMO, which is the core particle, and a step of forming the coating layer on the surface of the LiMO.

### [Step of Manufacturing LiMO]

In a case of manufacturing the LiMO, it is preferable that the MCC containing a metal other than lithium, which is a metal constituting the LiMO, be first prepared, and the MCC be calcined with an appropriate lithium compound.

Specifically, the “MCC” is a compound containing Ni, which is an essential metal, and any one or more metals selected from Co, Mn, Al, W, B, Mo, Zn, Sn, Zr, Ga, La, Ti, Nb, or V.

As the MCC, a metal composite hydroxide or a metal composite oxide is preferable.

Hereinafter, an example of a method for manufacturing the LiMO will be described by dividing the method into a step of manufacturing the MCC and a step of manufacturing the LiMO.

### (Step of Manufacturing MCC)

The MCC can be manufactured by a generally known co-precipitation method. As the co-precipitation method, it is possible to use a commonly known batch co-precipitation method or a continuous co-precipitation method. Hereinafter, the method for manufacturing the MCC will be described in detail using, as a metal, a metal composite hydroxide containing Ni, Co, and Mn as an example.

First, a nickel salt solution, a cobalt salt solution, a manganese salt solution, and a complexing agent are reacted with one another by a co-precipitation method, particularly, a continuous co-precipitation method described in JP-A-2002-201028, thereby manufacturing a metal composite hydroxide represented by Ni_{(1-y-z)}Co_{y}Mn_{z}(OH)₂ (in the formula, y+z=1).

A nickel salt which is a solute of the above-described nickel salt solution is not particularly limited, and, for example, one or more of nickel sulfate, nickel nitrate, nickel chloride, and nickel acetate can be used.

As a cobalt salt which is a solute of the above-described cobalt salt solution, for example, one or more of cobalt sulfate, cobalt nitrate, cobalt chloride, and cobalt acetate can be used.

As a manganese salt which is a solute of the above-described manganese salt solution, for example, one or more of manganese sulfate, manganese nitrate, manganese chloride, and manganese acetate can be used.

The above-described metal salt is used in a proportion corresponding to the compositional ratio of NiₐCo_{b}Mn_{c}(OH)₂. That is, the amount of each of the metal salts used is set so that the molar ratio of Ni in the solute of the nickel salt solution, Co in the solute of the cobalt salt solution, and Mn in the solute of the manganese salt solution is to be 1−y−z:y:z corresponding to the compositional ratio of Ni_{(1-y-z)}Co_{y}Mn_{z}(OH)₂.

In addition, a solvent of the nickel salt solution, the cobalt salt solution, and the manganese salt solution is water. That is, the solvent of the nickel salt solution, the cobalt salt solution, and the manganese salt solution is an aqueous solution.

The complexing agent is a compound capable of forming a complex with a nickel ion, a cobalt ion, and a manganese ion in an aqueous solution. As the complexing agent, for example, ammonium ion donors (ammonium salts such as ammonium hydroxide, ammonium sulfate, ammonium chloride, ammonium carbonate, and ammonium fluoride), hydrazine, ethylenediaminetetraacetic acid, nitrilotriacetic acid, uracildiacetic acid, and glycine are exemplary examples.

In a case of using the complexing agent, the amount of the complexing agent contained in the mixed solution containing the nickel salt solution, the optional metal salt solution, and the complexing agent is, for example, a molar ratio of more than 0 and 2.0 or less with respect to the total number of moles of the metal salt. In a case of using the complexing agent, the amount of the complexing agent contained in the mixed solution containing the nickel salt solution, the cobalt salt solution, the manganese salt solution, and the complexing agent is, for example, a molar ratio of more than 0 and 2.0 or less with respect to the total number of moles of the metal salt.

In the co-precipitation method, in order to adjust the pH value of the mixed solution containing the nickel salt solution, the optional metal salt solution, and the complexing agent, an alkali metal hydroxide is added to the mixed solution before the pH of the mixed solution changes from alkaline to neutral. The alkali metal hydroxide is, for example, sodium hydroxide or potassium hydroxide.

The pH value in the present specification is defined as a value measured in a case where the temperature of the mixed solution is 40° C. The pH of the mixed solution is measured in a case where the temperature of the mixed solution sampled from a reaction vessel reaches 40° C.

In a case where the complexing agent in addition to the nickel salt solution, the cobalt salt solution, and the manganese salt solution described above is continuously supplied to the reaction vessel, Ni, Co, and Mn react with each other to form Ni_{(1-y-z)}Co_{y}Mn_{z}(OH)₂.

During the reaction, the temperature of the reaction vessel is controlled, for example, within a range of 20° C. to 80° C., preferably 30° C. to 70° C.

In addition, during the reaction, the pH value in the reaction vessel is controlled, for example, within a range of pH 9 to pH 13, preferably pH 11 to pH 13.

The substances in the reaction vessel are appropriately stirred and mixed together.

As the reaction vessel which is used in the continuous co-precipitation method, an overflow type reaction vessel can be used to separate the formed reaction precipitate.

By appropriately controlling the concentrations of the metal salts in the metal salt solutions supplied to the reaction vessel, the stirring speed, the reaction temperature, the reaction pH, calcining conditions described later, and the like, it is possible to control various physical properties of the LiMO which is finally obtained.

In addition to the control of the above-described conditions, an oxidation state of a reaction product to be obtained may be controlled by supplying a variety of gases, for example, an inert gas such as nitrogen, argon, or carbon dioxide, an oxidizing gas such as air or oxygen, or a gas mixture thereof to the reaction vessel.

As a compound (oxidizing agent) which oxidizes the reaction product to be obtained, it is possible to use peroxides such as hydrogen peroxide, peroxide salts such as permanganate, perchlorates, hypochlorites, nitric acid, halogens, ozone, or the like.

As a compound which reduces the reaction product to be obtained, it is possible to use organic acids such as oxalic acid and formic acid, sulfites, hydrazines, or the like.

In detail, the inside of the reaction vessel may be an inert atmosphere. In a case where the inside of the reaction vessel is an inert atmosphere, a metal which is more easily oxidized than Ni among the metals contained in the mixed solution is prevented from aggregating earlier than Ni. Therefore, a uniform metal composite hydroxide can be obtained.

In addition, the inside of the reaction vessel may be an appropriate oxidizing atmosphere. The oxidizing atmosphere may be an oxygen-containing atmosphere formed by mixing an oxidizing gas into an inert gas, and when the inside of the reaction vessel, in which an oxidizing agent may be present in an inert gas atmosphere, is an appropriate oxidizing atmosphere, a transition metal which is contained in the liquid mixture is appropriately oxidized, which makes it easy to control the form of the metal composite oxide.

As oxygen or the oxidizing agent in the oxidizing atmosphere, a sufficient number of oxygen atoms need to be present in order to oxidize the transition metal.

In a case where the oxidizing atmosphere is an oxygen-containing atmosphere, the atmosphere in the reaction vessel can be controlled by a method in which an oxidizing gas is bubbled or the like in the liquid mixture, which aerates the oxidizing gas into the reaction vessel.

After the above-described reaction, the obtained reaction precipitate is washed with water and dried, whereby the MCC is obtained. In the present embodiment, a nickel cobalt manganese hydroxide is obtained as the MCC. In addition, in a case where the reaction precipitate is washed with water only, and foreign matter derived from the mixed solution remains, the reaction precipitate may be washed with weak acid water or an alkaline solution, as necessary. As the alkaline solution, an aqueous solution containing sodium hydroxide or potassium hydroxide is an exemplary example.

By adjusting the pH in the reaction vessel in a case of manufacturing the nickel cobalt manganese composite hydroxide, the liquid supply rate, the holding temperature, and the holding time in a case of heating the reaction vessel, the shape of the particles of the nickel cobalt manganese composite hydroxide can be controlled. In addition, in a case where the particles of the nickel cobalt manganese composite hydroxide are pulverized, the aggregation is broken and the specific surface area is increased.

In the above-described example, the nickel cobalt manganese composite hydroxide is manufactured, but a nickel cobalt manganese composite oxide may be prepared.

For example, the nickel cobalt manganese composite oxide can be prepared by oxidizing the nickel cobalt manganese composite hydroxide. Regarding the calcining time for oxidation, the total time taken while the temperature begins to be raised and reaches the calcining temperature and the holding of the composite metal hydroxide at the calcining temperature ends is preferably set to 1 hour or longer and 30 hours or shorter. The temperature rising rate in the heating step until the highest holding temperature is reached is preferably 180° C./hour or more, more preferably 200° C./hour or more, and particularly preferably 250° C./hour or more.

The highest holding temperature in the present specification is the highest holding temperature of the atmosphere in a calcining furnace in a calcining step and means the calcining temperature in the calcining step. In the case of a main calcining step having a plurality of heating steps, the highest holding temperature means the highest temperature in each heating step.

The temperature rising rate in the present specification is calculated from the time taken while the temperature begins to be raised and reaches the highest holding temperature in a calcining device and a temperature difference between the temperature in the calcining furnace of the calcining device at the time of beginning to raise the temperature and the highest holding temperature.

### (Step of Manufacturing LiMO)

In the step, after drying the metal composite oxide or metal composite hydroxide described above, the metal composite oxide or metal composite hydroxide is mixed with a lithium compound.

As the lithium compound, it is possible to use any one of lithium carbonate, lithium nitrate, lithium acetate, lithium hydroxide, lithium oxide, lithium chloride, and lithium fluoride, or a mixture of two or more thereof. Among these, any one or both of lithium hydroxide and lithium carbonate are preferable.

In a case where the lithium hydroxide contains lithium carbonate as an impurity, the content of the lithium carbonate in the lithium hydroxide is preferably 5% by mass or less.

Drying conditions of the metal composite oxide or metal composite hydroxide described above are not particularly limited. The drying conditions may be, for example, any of the following conditions 1) to 3).
1) Conditions in which the metal composite oxide or metal composite hydroxide is not oxidized or reduced;
specifically, a drying condition in which an oxide remains as an oxide as it is or a drying condition in which a hydroxide remains as a hydroxide as it is.
2) a condition in which the metal composite hydroxide is oxidized; specifically, a drying condition in which the hydroxide is oxidized to an oxide.
3) a condition in which the metal composite oxide is reduced; specifically, a drying condition in which the oxide is reduced to a hydroxide.

Under the condition in which oxidation or reduction do not occur, an inert gas such as nitrogen, helium or argon may be used as the atmosphere during the drying.

Under the condition in which the hydroxide is oxidized, oxygen or air may be used as the atmosphere during the drying.

In addition, under the condition in which the metal composite oxide is reduced, a reducing agent such as hydrazine and sodium sulfite may be used in the inert gas atmosphere during the drying.

After the drying, the metal composite oxide or metal composite hydroxide may be classified as appropriate.

The above-described lithium compound and the MCC are used in consideration of the compositional ratio of the final target product. For example, in a case where the nickel-cobalt-manganese composite compound is used as the MCC, the lithium compound and the MCC are used in a proportion corresponding to the compositional ratio of LiNi_{(1-y-z)}Co_{y}Mn_{z}O₂ (in the formula, y+z=1). In addition, in a case where Li is excessive (the content molar ratio is more than 1) in the LiMO as the final target product, the lithium compound and the MCC are mixed at a proportion of a molar ratio of Li contained in the lithium compound to the metal element contained in the MCC being more than 1.

The mixture of the nickel-cobalt-manganese composite compound and the lithium compound is calcined to obtain a lithium-nickel-cobalt-manganese composite oxide. In the calcining, dry air, an oxygen atmosphere, an inert atmosphere, or the like is used depending on a desired composition, and a plurality of heating steps are carried out as necessary.

As a holding temperature, specifically, a range of 200° C. to 1150° C. is an exemplary example, preferably 300° C. to 1050° C. and more preferably 500° C. to 1000° C.

In addition, as a time for holding at the above-described holding temperature, 0.1 to 20 hours is an exemplary example, preferably 0.5 to 10 hours. A temperature rising rate up to the above-described holding temperature is usually 50 to 400° C./hour, and a temperature lowering rate from the above-described holding temperature to room temperature is usually 10 to 400° C./hour. In addition, as the calcining atmosphere, it is possible to use air, oxygen, nitrogen, argon, or a mixed gas thereof.

### (Arbitrary Drying Step)

It is preferable that the obtained calcined product be dried. By drying after the calcining, it is possible to reliably remove moisture remaining in the fine pores. The moisture remaining in the fine pores causes deterioration of the solid electrolyte in a case of manufacturing the electrode. By drying after the calcining to remove the moisture remaining in the fine pores, the deterioration of the solid electrolyte can be prevented.

A drying method after the calcining is not particularly limited as long as the moisture remaining in the LiMO can be removed.

As the drying method after the calcining, for example, a vacuum drying treatment under vacuum or a drying treatment using a hot air dryer is preferable.

The drying temperature is, for example, preferably 80° C. to 140° C.

A drying time is not particularly limited as long as the moisture can be removed, and for example, 5 to 12 hours is an exemplary example.

### (Arbitrary Crushing Step)

It is preferable that the obtained calcined product after the calcining be crushed. By crushing the calcined product, the calcined product is crushed starting from the large pores. Therefore, a LiMO in which the proportion of large pores is small is obtained.

In a case where there are a plurality of calcining steps, the calcined product may be subjected to a crushing treatment and the crushed product of the calcined product may be further calcined.

By the calcining after the crushing, it is possible to remove foreign substances such as lithium carbonate, generated on the surface of the crushed product.

As the crushing treatment, for example, crushing using a mass colloider crusher is an exemplary example.

A rotation speed of the crusher is preferably in a range of 500 to 2,000 rpm.

The LiMO is obtained by the above-described steps.

### [Step of Forming Coating Layer]

The step of forming the coating layer on the surface of the particles of the LiMO will be described. First, a coating material raw material and the LiMO are mixed with each other. Next, the coating layer can be formed on the surface of the particles of the LiMO by performing a heat treatment as necessary.

As the coating material raw material, an oxide, a hydroxide, a carbonate, a nitrate, a sulfate, a halide, a formate, or an alkoxide of at least one element selected from the group consisting of Nb, Ta, Ti, Al, B, P, W, Zr, La, and Ge can be used with the above-described lithium compound. The compound containing at least one element selected from the group consisting of Nb, Ta, Ti, Al, B, P, W, Zr, La, and Ge is preferably an oxide.

The coating material raw material is, for example, a raw material of lithium niobate. In a case of forming the coating layer, a coating liquid containing the coating material raw material and a solvent is used.

In addition to the lithium niobate, lithium tantalate, lithium titanate, lithium aluminate, lithium tungstate, lithium phosphate, and lithium borate are exemplary examples.

As a Li source of the lithium niobate, for example, Li alkoxide, Li inorganic salt, and Li hydroxide are exemplary examples.

As the Li alkoxide, for example, ethoxy lithium and methoxy lithium are exemplary examples.

As the Li inorganic salt, for example, lithium nitrate, lithium sulfate, and lithium acetate are exemplary examples. As the Li hydroxide, for example, lithium hydroxide is an exemplary example.

As a Ta source of the lithium tantalate, tantalum oxide and pentaethoxytantalum are exemplary examples. As a Ti source of the lithium titanate, for example, titanium oxide and tetraethoxytitanium are exemplary examples. As an Al source of the lithium aluminate, aluminum oxide is an exemplary example. As a W source of the lithium tungstate, tungsten oxide is an exemplary example. As a P source of the lithium phosphate, ammonium dihydrogenphosphate and diammonium hydrogenphosphate are exemplary examples. As a B source of the lithium borate, boric acid and boron oxide are exemplary examples.

As a Nb source of the lithium niobate, for example, Nb alkoxide, Nb inorganic salt, Nb hydroxide, and Nb complex are exemplary examples.

As the Nb alkoxide, for example, pentaethoxy niobium, pentamethoxy niobium, penta-i-propoxy niobium, penta-n-propoxy niobium, penta-i-butoxy niobium, penta-n-butoxy niobium, and penta-sec-butoxy niobium are exemplary examples.

As the Nb inorganic salt, for example, niobium acetate and the like are exemplary examples.

As the Nb hydroxide, for example, niobium hydroxide is an exemplary example.

As the Nb complex, for example, a peroxo complex of Nb (peroxoniobate complex [Nb(O₂)₄]³⁻) is an exemplary example.

The coating liquid containing the peroxo complex of Nb has an advantage in that the amount of gas generated in the heat treatment step is smaller than that in the coating liquid containing the Nb alkoxide. By using the coating liquid in which the amount of gas generated is small, the density of the cathode material coating layer after the heat treatment can be increased, and the coated cathode active material having a low resistance can be manufactured.

As a method for preparing the coating liquid containing the peroxo complex of Nb, for example, a method of adding hydrogen peroxide water and ammonia water to a Nb oxide or a Nb hydroxide is an exemplary example. Addition amounts of the hydrogen peroxide water and the ammonia water may be appropriately adjusted so that a transparent solution (uniform solution) is obtained.

The type of the solvent in the coating liquid is not particularly limited, and alcohol, water, and the like are exemplary examples.

As the alcohol, for example, methanol, ethanol, propanol, butanol, and the like are exemplary examples. For example, in a case where the coating liquid contains an alkoxide, the solvent is preferably anhydrous alcohol or dewatered alcohol. On the other hand, for example, in a case where the coating liquid contains a peroxo complex of Nb, the solvent is preferably water.

A method of coating the surface of the LiMO with the coating liquid is not particularly limited, and a method using a roll-to-roll flow coating device can be suitably used. As the roll-to-roll flow coating device, for example, MP-01 manufactured by Powrex Corp. can be suitably used.

Preferred operating conditions of the roll-to-roll flow coating device are described below.

A coating liquid spraying amount of the coating liquid is preferably adjusted to a range of 2 to 5 g/min.

An air temperature is preferably adjusted to a range of 180° C. to 200° C.

A spray air flow rate of a two-fluid nozzle is preferably 20 to 40 NL/min.

A rotation speed of a rotor is preferably adjusted to 200 to 400 rpm.

The property of the air supply gas is preferably dry air or an inert gas.

In the coating step of the coating liquid, by controlling the operating conditions within the above-described range, the CAM satisfying (1) and (2) is obtained.

In the present embodiment, the total amount of the element A per unit area is a product of the total amount of the element A to be sprayed and a carrying efficiency.

The total amount of the element A to be sprayed is determined by the concentration of the coating liquid, the spraying speed, and the spraying time.

The carrying efficiency is a proportion of the element A carried on the surface of the particle, which is used in the formation of the coating layer, to the total amount of the element A to be sprayed.

The carrying efficiency can be controlled by appropriately adjusting the operating conditions of the coating machine. In a case where the above-described operating conditions are within the above-described range, a stable and high carrying efficiency can be obtained.

A preferred range of the substance amount [mol] of the element A to be sprayed is set to a substance amount [mol/m²] per unit area, which is obtained by dividing the substance amount by the total surface area [m²] of the LiMO (specific surface area [m²/g]×charged amount [g]). The value is preferably less than 3.0×10⁻⁴ [mol/m²], and more preferably 2.9×10⁻⁴ [mol/m²] or less. In addition, the lower limit value of the substance amount of the element A to be sprayed per unit area is preferably 0.5×10⁻⁴ [mol/m²] or more, and more preferably 0.9×10⁻⁴ [mol/m²] or more.

The substance amount of the element A to be sprayed per unit area is preferably 0.5×10⁻⁴ [mol/m²] or more and less than 3.0×10⁻⁴ [mol/m²], and more preferably 0.9×10⁻⁴ [mol/m²] or more and 2.9×10⁻⁴ [mol/m²] or less.

In addition, the standard deviation of the element A increases or decreases depending on the total amount of the element A. The standard deviation tends to decrease as the presence amount of the element A decreases, and the standard deviation tends to increase as the presence amount of the element A increases. This is because the coating machine operating conditions are constant, and thus “Coefficient of variation (Standard deviation÷Average value)” is substantially constant. The above-described carrying efficiency also fluctuates in a case where the coating machine operating conditions change, but the standard deviation is unlikely to increase as long as the operating conditions are within the above-described range.

In a case where the coating liquid and the LiMO are mixed and heat-treated, heat treatment conditions may be different depending on the type of the coating material raw material. As the heat treatment conditions, the heat treatment temperature and the holding time of the heat treatment are exemplary examples.

For example, in a case where the coating material raw material contains niobium, it is preferable to perform the heat treatment at a temperature of 200° C. to 500° C. for 2 hours or more and 10 hours or less. In a case where the heat treatment temperature exceeds 500° C., aggregation of the coating layer may occur, and unevenness of the thickness of the coating layer or an uncoated portion may increase.

The heat treatment temperature in the present specification means a temperature of an atmosphere in a heating furnace, and is the highest temperature of the holding temperature in the heat treatment step. The “highest temperature of the holding temperature” may be referred to below as the highest holding temperature. In a case where the heat treatment step includes a plurality of heating steps, the heat treatment temperature means a temperature in a case of being heated at the highest holding temperature in each heating step.

The CAM in which the coating layer is formed on the surface of the LiMO is obtained by heat-treating a mixture of the coating material raw material and the LiMO under the heat treatment conditions of the above-described coating layer.

The CAM is appropriately crushed and classified to be a cathode active material for lithium-ion batteries.

### <Liquid-Type Lithium Secondary Battery>

Next, a configuration of a suitable liquid-type lithium secondary battery in a case of using the CAM according to the present embodiment will be described.

In addition, a cathode suitable for liquid-type lithium secondary batteries (hereinafter, may be referred to as a cathode) in a case of using the CAM according to the present embodiment will be described.

Furthermore, a liquid-type lithium secondary battery suitable as a cathode application will be described.

An example of a liquid-type lithium secondary battery suitable for a case in which the CAM according to the present embodiment is used has a cathode, an anode, a separator interposed between the cathode and the anode, and an electrolytic solution disposed between the cathode and the anode.

An example of the liquid-type lithium secondary battery has a cathode, an anode, a separator interposed between the cathode and the anode, and an electrolytic solution disposed between the cathode and the anode.

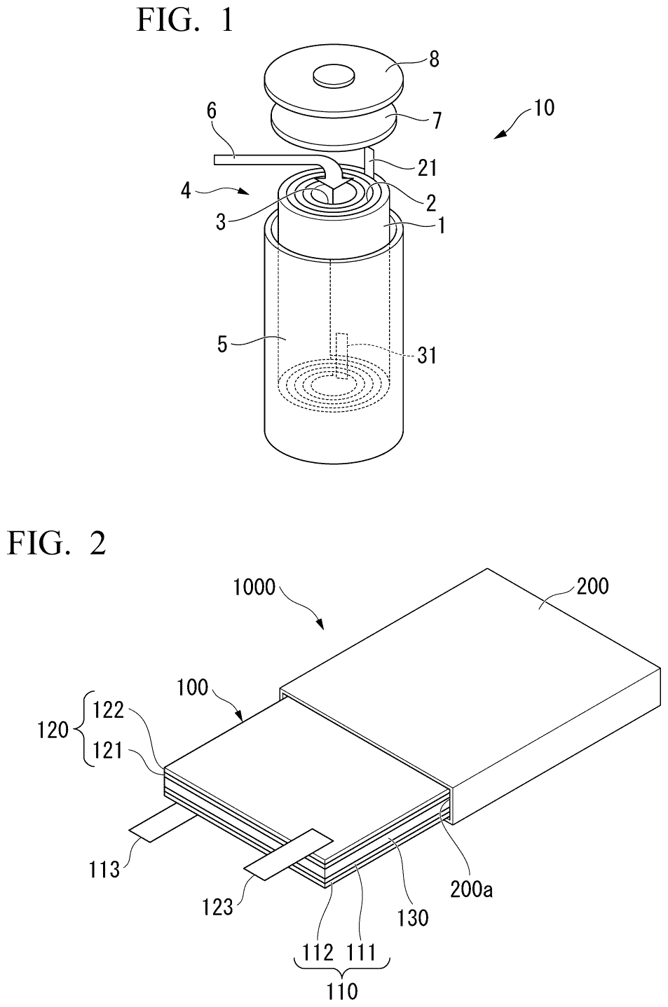

FIG. 1 is a schematic view showing an example of the liquid-type lithium secondary battery. A cylindrical lithium secondary battery 10 is manufactured as described below.

First, as shown in FIG. 1, a pair of separators 1 having a strip shape, a strip-shaped cathode 2 having a cathode lead 21 at one end, and a strip-shaped anode 3 having an anode lead 31 at one end are laminated in order of the separator 1, the cathode 2, the separator 1, and the anode 3 and are wound to form an electrode group 4.

Next, the electrode group 4 and an insulator (not shown) are accommodated in a battery can 5, and a can bottom is sealed. The electrode group 4 is impregnated with an electrolytic solution 6, and an electrolyte is disposed between the cathode 2 and the anode 3. Furthermore, an upper portion of the battery can 5 is sealed with a top insulator 7 and a sealing body 8, whereby the liquid-type lithium secondary battery 10 can be manufactured.

As a shape of the electrode group 4, for example, a columnar shape in which the cross-sectional shape is a circle, an ellipse, a rectangle, or a rectangle with rounded corners in a case where the electrode group 4 is cut in a direction perpendicular to a winding axis can be an exemplary example.

In addition, as the shape of the liquid-type lithium secondary battery having such an electrode group 4, a shape that is specified by IEC60086, which is a standard for batteries specified by the International Electrotechnical Commission (IEC) or by JIS C 8500, can be adopted. For example, shapes such as a cylindrical shape and a square shape can be exemplary examples.

Furthermore, the liquid-type lithium secondary battery is not limited to the above-described winding-type configuration, and may have a lamination-type configuration of a laminated structure in which the cathode, the separator, the anode, and the separator are repeatedly stacked. As the lamination-type lithium secondary battery, a so-called coin-type battery, button-type battery, or paper-type (or sheet-type) battery can be exemplary examples.

Hereinafter, each configuration will be described in order.

### (Cathode)

The cathode can be manufactured by, first, preparing a cathode material mixture containing the CAM, a conductive material, and a binder, and supporting the cathode material mixture with a cathode current collector.

### (Conductive Material)

As the conductive material in the cathode, a carbon material can be used. As the carbon material, graphite powder, carbon black (for example, acetylene black), a fibrous carbon material, and the like can be exemplary examples.

A proportion of the conductive material in the cathode material mixture is preferably 5 to 20 parts by mass with respect to 100 parts by mass of the CAM.

### (Binder)

As the binder in the cathode, a thermoplastic resin can be used.

As the thermoplastic resin, polyimide resins; fluororesins such as polyvinylidene fluoride (hereinafter, may be referred to as PVdF) and polytetrafluoroethylene; polyolefin resins such as polyethylene and polypropylene, and the resins described in WO2019/098384A1 or US2020/0274158A1 can be exemplary examples.

### (Cathode Current Collector)

As the cathode current collector in the cathode, a strip-shaped member formed of a metal material such as Al, Ni, and stainless steel as a forming material can be used.

As a method for supporting the cathode material mixture by the cathode current collector, a method in which a paste of the cathode material mixture is prepared using an organic solvent, the paste of the cathode material mixture to be obtained is applied to and dried on at least one surface side of the cathode current collector, and the cathode material mixture is fixed by performing an electrode pressing step is an exemplary example.

As the organic solvent which can be used in a case where the paste of the cathode material mixture is prepared, N-methyl-2-pyrrolidone (hereinafter, may be referred to as NMP) is an exemplary example.

As the method for applying the paste of the cathode material mixture to the cathode current collector, a slit die coating method, a screen coating method, a curtain coating method, a knife coating method, a gravure coating method, and an electrostatic spraying method are exemplary examples.

The cathode can be manufactured by the method mentioned above.

### (Anode)

It is sufficient that the anode in the lithium secondary battery be a material which can be doped with lithium-ions and from which lithium-ions can be de-doped at a potential lower than that of the cathode, and an electrode in which an anode material mixture containing an anode active material is supported with an anode current collector and an electrode formed of an anode active material alone are exemplary examples.

### (Anode Active Material)

As the anode active material in the anode, carbon materials, a chalcogen compound (oxide, sulfide, or the like), a nitride, a metal, or an alloy and which can be doped with lithium-ions and from which lithium-ions can be de-doped at a potential lower than that of the cathode are exemplary examples.

As the carbon material which can be used as the anode active material, graphite such as natural graphite or artificial graphite, cokes, carbon black, carbon fiber, and an organic polymer compound-calcined body can be exemplary examples.

As oxides which can be used as the anode active material, oxides of silicon represented by a formula SiOₓ (here, x is a positive real number), such as SiO₂ and SiO; oxides of tin represented by a formula SnOₓ (here, x is a positive real number), such as SnO₂ and SnO; and metal composite oxides containing lithium and titanium, such as Li₄Ti₅O₁₂ and LiVO₂ can be exemplary examples.

In addition, as the metal which can be used as the anode active material, lithium metal, silicon metal, tin metal, and the like can be exemplary examples. As the material which can be used as the anode active material, the materials described in WO2019/098384A1 or US2020/0274158A1 may be used.

These metals and alloys can be mainly used alone as an electrode after being processed into, for example, a foil shape.

Among the anode active materials, a carbon material containing graphite such as natural graphite or artificial graphite as a main component is preferably used because the potential of the anode rarely changes (potential flatness is favorable) from a uncharged state to a fully-charged state during charging, the average discharging potential is low, the capacity retention rate at the time of repeatedly charging and discharging the lithium secondary battery is high (the cycle characteristics are favorable), and the like. A shape of the carbon material may be, for example, any of a flaky shape such as natural graphite, a spherical shape such as mesocarbon microbeads, a fibrous shape such as a graphitized carbon fiber, or an aggregate of fine powder.

The anode material mixture may contain a binder as necessary. As the binder, thermoplastic resins can be exemplary examples, and specifically, PVdF, thermoplastic polyimide, carboxymethylcellulose (hereinafter, may be described as CMC), styrene-butadiene rubber (hereinafter, may be described as SBR), polyethylene, and polypropylene can be exemplary examples.

### (Anode Current Collector)

As the anode current collector in the anode, a strip-shaped member formed of a metal material such as Cu, Ni, and stainless steel as a forming material can be exemplary examples.

As a method for supporting the anode material mixture by the anode current collector, similar to the case of the cathode, a method in which the anode material mixture is formed by pressurization and a method in which a paste of the anode material mixture is prepared using a solvent or the like, applied and dried on the anode current collector, and the anode material mixture is compressed by pressing are exemplary examples.

### (Separator)

As the separator in the lithium secondary battery, it is possible to use, for example, a material which is made of a polyolefin resin such as polyethylene or polypropylene, a fluororesin, or a nitrogen-containing aromatic polymer and has a form such as a porous film, a non-woven fabric, or a woven fabric. In addition, the separator may be formed using two or more of these materials or the separator may be formed by laminating these materials. In addition, the separators described in JP-A-2000-030686 or US2009/0111025A1 may be used.

### (Electrolytic Solution)

The electrolytic solution in the lithium secondary battery contains an electrolyte and an organic solvent.

As the electrolyte contained in the electrolytic solution, lithium salts such as LiClO₄ and LiPF₆ are exemplary examples, and a mixture of two or more thereof may be used.

As the organic solvent contained in the above-described electrolytic solution, for example, carbonates such as propylene carbonate, ethylene carbonate, dimethyl carbonate, diethyl carbonate, and ethyl methyl carbonate can be used.

As the organic solvent, it is preferable to use a mixture of two or more of the organic solvents. Among these, a mixed solvent containing carbonates is preferable, and a mixed solvent of a cyclic carbonate and a non-cyclic carbonate or a mixed solvent of a cyclic carbonate and an ether is more preferable.

In addition, as the electrolytic solution, it is preferable to use an electrolytic solution containing a lithium salt containing fluorine such as LiPF₆ and an organic solvent having a fluorine substituent since the safety of the lithium secondary battery to be obtained is enhanced. As the electrolyte and the organic solvent that are contained in the electrolytic solution, the electrolytes and the organic solvents described in WO2019/098384A1 or US2020/0274158A1 may be used.

### <Solid Lithium Secondary Battery>

Next, a cathode for solid lithium secondary batteries, in which the CAM according to the embodiment of the present invention is used, and a solid lithium secondary battery including the cathode will be described while describing the configuration of the solid lithium secondary battery.

FIG. 2 is a schematic view showing an example of the solid lithium secondary battery according to the present embodiment.

A solid lithium secondary battery 1000 shown in FIG. 2 has a laminate 100 having a cathode 110, an anode 120, and a solid electrolyte layer 130, and an exterior body 200 accommodating the laminate 100. In addition, the solid lithium secondary battery 1000 may have a bipolar structure in which the CAM and an anode active material are disposed on both sides of a current collector. As specific examples of the bipolar structure, for example, the structures described in JP-A-2004-95400 are exemplary examples. A material which configures each member will be described below.

The laminate 100 may have an external terminal 113 which is connected to a cathode current collector 112 and an external terminal 123 which is connected to an anode current collector 122. In addition, the solid lithium secondary battery 1000 may have a separator between the cathode 110 and the anode 120.

The solid lithium secondary battery 1000 further has an insulator (not shown) which insulates the laminate 100 and the exterior body 200 from each other and a sealant (not shown) which seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been carried out into a bag shape can also be used.

As the shape of the solid lithium secondary battery 1000, for example, shapes such as a coin-type, a button type, a paper-type (or a sheet-type), a cylindrical type, a square shape, and a laminate type (pouch type) can be exemplary examples.

As the example of the solid lithium secondary battery 1000, a form in which one laminate 100 is provided is shown in the drawings, but the present embodiment is not limited thereto. The solid lithium secondary battery 1000 may have a configuration in which the laminate 100 is used as a unit cell and a plurality of unit cells (laminates 100) is sealed inside the exterior body 200.

Hereinafter, each configuration will be described in order.

### (Cathode)

The cathode 110 of the present embodiment has a cathode active material layer 111 and a cathode current collector 112.

The cathode active material layer 111 contains CAM, which is one aspect of the present invention described above, and a solid electrolyte. In addition, the cathode active material layer 111 may contain a conductive material and a binder.

### (Solid Electrolyte)

As the solid electrolyte which is contained in the cathode active material layer 111 of the present embodiment, a solid electrolyte which has lithium-ion conductivity and used in known solid lithium secondary batteries can be adopted. As the solid electrolyte, an inorganic electrolyte and an organic electrolyte can be exemplary examples. As the inorganic electrolyte, an oxide-based solid electrolyte, a sulfide-based solid electrolyte, and a hydride-based solid electrolyte can be exemplary examples. As the organic electrolyte, polymer-based solid electrolytes are exemplary examples. As each electrolyte, compounds described in WO2020/208872A1, US2016/0233510A1, US2012/0251871A1, and US2018/0159169A1 are exemplary examples, and the following compounds are exemplary examples.

### (Oxide-Based Solid Electrolyte)

As the oxide-based solid electrolyte, for example, a perovskite-type oxide, a NASICON-type oxide, a LISICON-type oxide, a garnet-type oxide, and the like are exemplary examples. As specific examples of each oxide, compounds described in WO2020/208872A1, US2016/0233510A1, and US2020/0259213A1 are exemplary examples, and for example, the following compounds are exemplary examples.

As the perovskite-type oxide, Li—La—Ti-based oxides such as LiₐLa₁₋ₐTiO₃ (0<a<1), Li—La—Ta-based oxides such as Li_{b}La_{1-b}TaO₃ (0<b<1), Li—La—Nb-based oxides such as Li_{c}La_{1-c}NbO₃ (0<c<1), and the like are exemplary examples.

As the NASICON-type oxide, Li_{1+d}Al_{d}Ti_{2-d}(PO₄)₃ (0≤d≤1) and the like are exemplary examples. The NASICON-type oxide is an oxide represented by LiₘM¹ₙM²ₒPₚO_{q} (in the formula, M¹ is one or more elements selected from the group consisting of B, Al, Ga, In, C, Si, Ge, Sn, Sb, and Se; M² is one or more elements selected from the group consisting of Ti, Zr, Ge, In, Ga, Sn, and Al; and m, n, o, p, and q are random positive numbers).

As the LISICON-type oxide, oxides represented by Li₄M³O₄-Li₃M⁴O₄ (M³ is one or more elements selected from the group consisting of Si, Ge, and Ti; and M⁴ is one or more elements selected from the group consisting of P, As, and V) and the like are exemplary examples.

As the garnet-type oxide, Li—La—Zr-based oxides such as Li₇La₃Zr₂O₁₂ (also referred to as LLZ) are exemplary examples.

The oxide-based solid electrolyte may be a crystalline material or an amorphous material.

### (Sulfide-Based Solid Electrolyte)

As the sulfide-based solid electrolyte, Li₂S—P₂S₅-based compounds, Li₂S—SiS₂-based compounds, Li₂S—GeS₂-based compounds, Li₂S—B₂S₃-based compounds, LiI—Si₂S—P₂S₅-based compounds, LiI—Li₂S—P₂O₅-based compounds, LiI—Li₃PO₄—P₂S₅-based compounds, Li₁₀GeP₂S₁₂, and the like can be exemplary examples.

In the present specification, the expression “-based compound” that indicates the sulfide-based solid electrolyte is used as a general term for solid electrolytes mainly containing a raw material written before “-based compound” such as “Li₂S” or “P₂S₅”. For example, the Li₂S—P₂S₅-based compounds include solid electrolytes mainly containing Li₂S and P₂S₅ and further containing a different raw material. A proportion of Li₂S which is contained in the Li₂S—P₂S₅-based compound is, for example, 50% to 90% by mass with respect to the entire Li₂S—P₂S₅-based compound. A proportion of P₂S₅ which is contained in the Li₂S—P₂S₅-based compound is, for example, 10% to 50% by mass with respect to the entire Li₂S—P₂S₅-based compound. In addition, a proportion of the different raw material which is contained in the Li₂S—P₂S₅-based compound is, for example, 0% to 30% by mass with respect to the entire Li₂S—P₂S₅-based compound. In addition, the Li₂S—P₂S₅-based compounds also include solid electrolytes containing Li₂S and P₂S₅ in different mixing ratios.

As the Li₂S—P₂S₅-based compounds, Li₂S—P₂S₅, Li₂S—P₂S₅—LiI, Li₂S—P₂S₅—LiCl, Li₂S—P₂S₅—LiBr, Li₂S—P₂S₅—LiI—LiBr, Li₂S—P₂S₅—Li₂O, Li₂S—P₂S₅—Li₂O—LiI, Li₂S—P₂S₅—ZₘSₙ (m and n are positive numbers; and Z is Ge, Zn, or Ga), and the like are exemplary examples.

As the Li₂S—SiS₂-based compounds, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—SiS₂—P₂S₅—LiCl, Li₂S—SiS₂—Li₃PO₄, Li₂S—SiS₂—Li₂SO₄, Li₂S—SiS₂-LiₓMO_{y} (x and y are positive numbers; and M is P, Si, Ge, B, Al, Ga, or In), and the like are exemplary examples.

As the Li₂S—GeS₂-based compounds, Li₂S—GeS₂, Li₂S—GeS₂—P₂S₅, and the like are exemplary examples.

The sulfide-based solid electrolyte may be a crystalline material or an amorphous material.

### (Hydride-Based Solid Electrolyte)

As the hydride-based solid electrolyte material, LiBH₄, LiBH₄-3KI, LiBH₄—PI₂, LiBH₄—P₂S₅, LiBH₄-LiNH₂, 3LiBH₄—LiI, LiNH₂, Li₂AlH₆, Li(NH₂)₂I, Li₂NH, LiGd(BH₄)₃Cl, Li₂(BH₄)(NH₂), Li₃(NH₂)I, Li₄(BH₄)(NH₂)₃, and the like can be exemplary examples.

### (Polymer-Based Solid Electrolyte)

As the polymer-based solid electrolyte, for example, organic polymer electrolytes such as polymer compounds containing one or more selected from the group consisting of a polyethylene oxide-based polymer compound, a polyorganosiloxane chain, and a polyoxyalkylene chain can be exemplary examples. In addition, it is also possible to use a so-called gel-type electrolyte in which a non-aqueous electrolytic solution is held in a polymer compound.

It is possible to use two or more kinds of the solid electrolytes in combination in a range in which the effects of the invention are not impaired.

### (Conductive Material and Binder)

As the conductive material contained in the cathode active material layer 111, the materials described in (Conductive material) above can be used. In addition, as for the proportion of the conductive material in the cathode material mixture, the proportions described in (Conductive material) above can be applied in the same manner. In addition, as the binder contained in the cathode, the materials described in (Binder) above can be used.

### (Cathode Current Collector)

As the cathode current collector 112 included in the cathode 110, the materials described in (Cathode current collector) above can be used.

As a method for supporting the cathode active material layer 111 with the cathode current collector 112, a method in which the cathode active material layer 111 is formed by pressurization on the cathode current collector 112 is an exemplary example. A cold press or a hot press can be used for the pressurization.

In addition, the cathode active material layer 111 may be supported with the cathode current collector 112 by preparing a paste of a mixture of the CAM, the solid electrolyte, the conductive material, and the binder using an organic solvent to produce a cathode material mixture, applying and drying the cathode material mixture to be obtained on at least one surface of the cathode current collector 112, and fixing the cathode material mixture by pressing.

In addition, the cathode active material layer 111 may be supported with the cathode current collector 112 by preparing a paste of a mixture of the CAM, the solid electrolyte, and the conductive material using an organic solvent to produce a cathode material mixture, applying and drying the cathode material mixture to be obtained on at least one surface of the cathode current collector 112, and calcining the cathode material mixture.

As the organic solvent which can be used for the cathode material mixture, the same organic solvent as the organic solvent which can be used in the case of preparing the paste of the cathode material mixture described in (Cathode current collector) above can be used.

As a method of applying the cathode material mixture to the cathode current collector 112, the methods described in (Cathode current collector) above are exemplary examples.

The cathode 110 can be manufactured by the method mentioned above. As a specific combination of materials used for the cathode 110, a combination of the CAM described in the present embodiment and materials described in Tables 1 to 3 is an exemplary example.

TABLE 1

| Solid electrolyte | Binder | Conductive material |
|---|---|---|
| Perovskite-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| NASICON-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| LISICON-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Garnet-type oxide | Polyimide-based resin | Graphite powder |
| | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |

TABLE 2

| Solid electrolyte | Binder | Conductive material |
|---|---|---|
| Li₂S—P₂S₅-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₂S—SiS₂-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₂S—GeS₂-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₂S—B₂S₃-based | Polyimide-based resin | Graphite powder |
| compound | | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |

TABLE 3

| Solid electrolyte | Binder | Conductive material |
|---|---|---|
| LiI—Si₂S—P₂S₅-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| LiI—Li₂S—P₂O₅-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| LiI—Li₃PO₄—P₂S₅-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |
| Li₁₀GeP₂S₁₂-based | Polyimide-based | Graphite powder |
| compound | resin | Carbon black |
| | | Fibrous carbon material |
| | Fluororesin | Graphite powder |
| | | Carbon black |
| | | Fibrous carbon material |
| | Polyolefin resin | Graphite powder |
| | | Carbon black |
| | | Fibrous carbon material |

### (Anode)

The anode 120 has an anode active material layer 121 and the anode current collector 122.

The anode active material layer 121 contains an anode active material. In addition, the anode active material layer 121 may contain a solid electrolyte and a conductive material. As the anode active material, the anode current collector, the solid electrolyte, the conductive material, and a binder, those described above can be used.

As a method for supporting the anode active material layer 121 by the anode current collector 122, similar to the case of the cathode 110, a method in which the anode active material layer 121 is formed by pressurization, a method in which a paste-like anode material mixture containing an anode active material is applied and dried on the anode current collector 122 and the anode active material layer 121 is compressed by pressing, and a method in which a paste-like anode material mixture containing an anode active material is applied, dried and calcined on the anode current collector 122 are exemplary examples.

### (Solid Electrolyte Layer)

The solid electrolyte layer 130 has the above-described solid electrolyte.

The solid electrolyte layer 130 can be formed by depositing a solid electrolyte of an inorganic substance on the surface of the cathode active material layer 111 in the above-described cathode 110 by a sputtering method.

In addition, the solid electrolyte layer 130 can be formed by applying and drying a paste-like mixture containing a solid electrolyte on the surface of the cathode active material layer 111 in the above-described cathode 110. The solid electrolyte layer 130 may be formed by pressing the dried paste-like mixture and further pressurizing the paste-like mixture by a cold isostatic pressure method (CIP).

The laminate 100 can be manufactured by laminating the anode 120 on the solid electrolyte layer 130 provided on the cathode 110 as described above using a known method such that the anode active material layer 121 comes into contact with the surface of the solid electrolyte layer 130.

In the lithium secondary battery having the above-described configuration, since the CAM according to the present embodiment is used, it is possible to provide a lithium secondary battery capable of maintaining a discharge capacity even in a case where charging and discharging are repeated.

In addition, since the cathode having the above-described configuration has the CAM having the above-described configuration, the discharge capacity can be maintained even in a case where the charging and discharging of the lithium secondary battery are repeated.

Furthermore, since the lithium secondary battery having the above-described configuration has the above-described cathode, the lithium secondary battery is a secondary battery capable of maintaining the discharge capacity even in a case where charging and discharging are repeated.

As described above, although preferred examples of the embodiments according to the present invention have been described with reference to the accompanying drawings, the present invention is not limited to such examples. The variety of shapes, combinations, and the like of the individual constituent members described in the above-described examples are examples, and a variety of modifications are permitted based on design requirements and the like without departing from the gist of the present invention.

As one aspect, the present invention also includes the following aspects. “Cathode active material T” described below refers to “cathode active material powder for lithium secondary batteries, containing a core particle containing a lithium metal composite oxide as a forming material, and a coating layer coating at least a part of the core particle, in which the coating layer contains, as a forming material, an oxide containing at least one element A selected from the group consisting of Nb, Ta, Ti, Al, B, P, W, Zr, La, and Ge, and the following (1) and (2) are satisfied;

(1) a substance amount of the element A per unit area, which is calculated from analysis results by inductively coupled plasma mass spectrometry and a nitrogen adsorption BET method, is 3.0×10⁻⁴ mol/m² or less, and (2) a standard deviation of a compositional ratio of the element A to a total number of atoms in the CAM, which is calculated from a value obtained from an SEM-EDX analysis result, is 4.6 or more and 8.2 or less”.

(2-1) Use of the cathode active material T for a solid lithium-ion secondary battery.

(2-2) Use of the cathode active material T for a cathode used in a solid lithium-ion secondary battery.

(2-3) Use of the cathode active material T for manufacturing a solid lithium-ion secondary battery.

(2-4) Use of the cathode active material T for manufacturing a cathode used in a solid lithium-ion secondary battery.

(2-A) Use of (2-1), (2-2), (2-3), or (2-4) for a solid lithium-ion secondary battery containing an oxide-based solid electrolyte as a solid electrolyte.

(3-1) The cathode active material T which is in contact with a solid electrolyte layer.

(3-1-1) The cathode active material T according to (3-1), in which the solid electrolyte layer contains an oxide-based solid electrolyte.

(3-2) A cathode which is in contact with a solid electrolyte layer, the cathode including a cathode active material layer in contact with the solid electrolyte layer, and a current collector on which the cathode active material layer is laminated, in which the cathode active material layer contains the cathode active material T.

(3-3) A cathode which is in contact with a solid electrolyte layer, the cathode including a cathode active material layer in contact with the solid electrolyte layer, and a current collector on which the cathode active material layer is laminated, in which the cathode active material layer contains the cathode active material T and a solid electrolyte, the cathode active material T contains a plurality of particles, and the plurality of particles are filled with the solid electrolyte.

(3-4) The cathode according to (3-3), in which the solid electrolyte and the particles contained in the cathode active material layer are each in contact with the solid electrolyte layer.

(3-A) The cathode according to (3-2), (3-3), or (3-4), in which the solid electrolyte layer contains an oxide-based solid electrolyte.

(3-B) The cathode according to (3-2), (3-3), (3-4), or (3-A), in which the solid electrolyte contained in the cathode active material layer is an oxide-based solid electrolyte.

(3-5)

A solid lithium-ion secondary battery including: the cathode active material T according to any one of (3-1) or (3-1-1); or the cathode according to any one of (3-2), (3-3), (3-4), (3-A), or (3-B).

(4-1)

A charging method of a solid lithium-ion secondary battery, including providing a solid electrolyte layer by bringing a cathode into contact with an anode so that the cathode and the anode are not short-circuited; and applying a negative potential to the cathode and a positive potential to the anode from an external power supply, in which the cathode includes the cathode active material T.

(4-2)

A discharging method of a solid lithium-ion secondary battery, including providing a solid electrolyte layer by bringing a cathode into contact with an anode so that the cathode and the anode are not short-circuited; applying a negative potential to the cathode and a positive potential to the anode from an external power supply to charge the solid lithium-ion secondary battery; and connecting a discharge circuit to the cathode and the anode of the charged solid lithium-ion secondary battery, in which the cathode includes the cathode active material T.

(4-A) The charging method of a solid lithium-ion secondary battery according to (4-1) or the discharging method of a solid lithium-ion secondary battery according to (4-2), in which the solid electrolyte layer contains an oxide-based solid electrolyte.

### EXAMPLES

Hereinafter, the present invention will be described with reference to Examples, but the present invention is not limited thereto.

### <Composition Analysis of CAM>

The composition analysis of the CAM manufactured by the method described later was carried out by the method described in [Composition analysis] above.

### <Crystal Structure Analysis of CAM>

The crystal structure of the CAM manufactured by the method described later was carried out by the method described in [Crystal structure analysis] above.

### <Acquisition of (1)>

The substance amount of the element A was acquired by the method described in [Method for obtaining substance amount of element A] above.

### <Measurement of (2)>

From the results measured by the method described in [SEM-EDX measurement], the standard deviation of the compositional ratio of the element A to the total number of atoms in the CAM was calculated.

### <Measurement of (3)>

The method described in [Method for measuring surface presence rate of element A] above was performed for measurement.

An all-solid lithium-ion secondary battery was manufactured by the method described in <Manufacturing of all-solid lithium-ion secondary battery> above.

A liquid-type lithium secondary battery was manufactured by the method described in <Manufacturing of liquid-type lithium secondary battery> above.

The manufactured solid lithium secondary battery and liquid-type lithium secondary battery were subjected to a charging and discharging test according to the method described in <Charging and discharging test> above, and the battery performance was evaluated based on the value of the discharge capacity. A case where the rate characteristic of the all-solid battery described above (5 CA/0.1 CA discharge capacity ratio (%)) was less than 10% was evaluated as “less good”, and a case where the rate characteristic of the all-solid battery described above (5 CA/0.1 CA discharge capacity ratio (%)) was 10% or more was evaluated as “good”.

In addition, a case where the rate characteristic of the liquid-type lithium secondary battery described above (10 CA/0.2 CA discharge capacity ratio (%)) was less than 70% was evaluated as “less good”, and a case where the rate characteristic of the liquid-type lithium secondary battery described above (10 CA/0.2 CA discharge capacity ratio (%)) was 70% or more was evaluated as “good”.

### Example 1

### (Production of CAM-1)

### [Step of Producing LiMO]

After water was poured into a reaction vessel equipped with a stirrer and an overflow pipe, a sodium hydroxide aqueous solution was added thereto, and the liquid temperature was retained at 50° C.

A nickel sulfate aqueous solution, a cobalt sulfate aqueous solution, and a manganese sulfate aqueous solution were mixed with an atomic ratio of Ni, Co, and Mn of 0.58:0.20:0.22, thereby preparing a mixed raw material solution 1.

Next, the mixed raw material solution 1 was continuously added to the reaction vessel under stirring, using an ammonium sulfate aqueous solution as a complexing agent. A sodium hydroxide aqueous solution was added dropwise to the solution in the reaction vessel under a condition in which the pH of the solution was 12.1 (in a case where the temperature of the aqueous solution was 40° C.), thereby obtaining nickel-cobalt-manganese composite hydroxide particles.

The obtained nickel-cobalt-manganese composite hydroxide particles were washed, dewatered and isolated by a centrifugal separator, and dried at 105° C. for 20 hours to obtain a nickel-cobalt-manganese composite hydroxide 1.

The nickel-cobalt-manganese-composite hydroxide 1 and a lithium hydroxide monohydrate powder were weighed and mixed in a proportion of Li/(Ni+Co+Mn)=1.03 to obtain a mixture 1.

Thereafter, the mixture 1 was primary calcined at 650° C. for 5 hours in an oxygen atmosphere.

Next, secondary calcining was performed at 850° C. for 5 hours in an oxygen atmosphere to obtain a secondary calcined product.

The obtained secondary calcined product was crushed with a mass colloider-type crusher to obtain a crushed product.

The operating conditions and the mass colloider-type crusher device used were as follows.

### (Operating Conditions of Mass Colloider-Type Crusher)

Device used: MKCA6-5J manufactured by MASUKO SANGYO CO., LTD.
Rotation speed: 1,200 rpm
Interval: 100 μm

The obtained crushed product was sieved using a turbo screener to obtain LiMO-1. The operating conditions and sieving conditions of the turbo screener were as follows.

### [Operating Conditions and Sieving Conditions of Turbo Screener]

The obtained crushed product was sieved using a turbo screener (TS125×200 type, manufactured by FREUND TURBO.). The operating conditions of the turbo screener were as follows.

### (Operating Conditions of Turbo Screener)

Screen used: 45 μm mesh; Blade rotation speed: 1,800 rpm; Supply rate: 50 kg/hour.

### (Evaluation of LiMO-1)

A BET specific surface area of the LiMO-1 was 0.90 m²/g.

### [Step of Forming Coating Layer]

### (Step of Preparing Coating Liquid)

133.12 g of H₂O₂ water having a concentration of 30% by mass, 151.06 g of pure water, and 6.76 g of niobium oxide hydrate Nb₂O₅·nH₂O (niobium oxide manufactured by Mitsuwa Chemicals Co., Ltd.) were mixed with each other. Next, 13.44 g of ammonia water having a concentration of 28% by mass was added thereto, and the mixture was stirred. Furthermore, 1.93 g of LiOH H₂O was added thereto to obtain a coating liquid 1 containing a niobium peroxy complex and lithium.

In the coating liquid 1, a molar concentration of Li was 0.16 mol/kg. In the coating liquid 1, a molar concentration of Nb was 0.16 mol/kg. Since the substance amount of Nb contained in the coating liquid 1 was 0.040 mol, the substance amount of Nb per unit area sprayed was 0.9×10⁻⁴ mol/m².

A calculation method of the substance amount of Nb per unit area sprayed was as follows.

Since the specific surface area of the LiMO-1 was 0.90 m²/g and the charged amount thereof was 500 g, the total surface area of the LiMO-1 was 450 m² obtained by the product (0.90×500).

The substance amount of Nb per unit area sprayed was [0.040÷450], which was calculated to be 0.9×10⁻⁴ mol/m² from the total surface area of Nb contained in the above-described coating liquid 1 and the LiMO-1.

### (Coating Step)

A roll-to-roll flow coating device (MP-01, manufactured by Powrex Corp.) was used in the coating step. 500 g of the powder of the LiMO-1 was subjected to a pre-treatment of drying at 120° C. for 10 hours in a vacuum atmosphere.

Thereafter, the surface of the LiMO-1 was coated with the coating liquid 1 under the following conditions.
Introduced air: carbon dioxide-free dried air
Air supply volume: 0.23 m³/min
Air temperature: 200° C.
Coating liquid flow rate: 2.7 g/min
Spray air flow rate: 30 NL/min
Rotor rotation speed: 400 rpm

### (Heat Treatment Step)

After coating with the coating liquid 1, the coating film was heat-treated at 200° C. for 5 hours in an oxygen atmosphere to obtain CAM-1.

### [Evaluation of CAM-1]

The CAM-1 included a coating layer covering at least a part of the surface of the core particle consisting of the LiMO. As a result of measurement by the method described in [SEM-EDX measurement] above, the coating layer contained an oxide containing Nb.

In the CAM-1, a BET specific surface area was 0.96 m²/g, a substance amount of Nb was 0.8×10⁻⁴ mol/m², a standard deviation of the compositional ratio of Nb was 6.0, and a surface presence rate of Nb was 62%.

As a result of the crystal structure analysis of the CAM-1, the CAM-1 had a layered crystal structure.

As a result of the composition analysis of the CAM-1, in a case of being represented by a compositional formula of Li[Liₓ(Ni_{(1-y-z-w)}Co_{y}Mn_{z}M_{w})₁₋ₓ]O₂, x=0.09, y=0.21, z=0.22, M=Nb, and w=0.01.

### Example 2

### (Production of CAM-2)

### [Step of Producing LiMO]

LiMO-1 was obtained by the same method as described above.

### [Step of Forming Coating Layer]

### (Step of Preparing Coating Liquid)

177.42 g of H₂O₂ water having a concentration of 30% by mass, 201.33 g of pure water, and 9.065 g of niobium oxide hydrate Nb₂O₅·nH₂O (niobium oxide manufactured by Mitsuwa Chemicals Co., Ltd.) were mixed with each other. Next, 17.98 g of ammonia water having a concentration of 28% by mass was added thereto, and the mixture was stirred. Furthermore, 2.585 g of LiOH H₂O was added thereto to obtain a coating liquid 2 containing a niobium peroxy complex and lithium.

In the coating liquid 2, a molar concentration of Li was 0.16 mol/kg. In the coating liquid 2, a molar concentration of Nb was 0.16 mol/kg. Since the substance amount of Nb contained in the coating liquid 2 was 0.052 mol, the substance amount of Nb per unit area sprayed was 1.2×10⁻⁴ mol/m².

The substance amount of Nb per unit area sprayed was [0.052÷450], which was calculated by the same calculation method as in Example 1, and was calculated to be 1.2×10⁻⁴ mol/m².

### (Coating Step)

CAM-2 was produced by the same method as in Example 1, except that the coating liquid flow rate of the two-fluid nozzle was changed to 1.5 g/min.

### [Evaluation of CAM-2]

The CAM-2 included a coating layer covering at least a part of the surface of the core particle consisting of the LiMO. The coating layer had an oxide containing Nb.

In the CAM-2, a BET specific surface area was 1.07 m²/g, a substance amount of Nb was 1.2×10⁻⁴ mol/m², a standard deviation of the compositional ratio of Nb was 5.7, and a surface presence rate of Nb was 68%.

As a result of the crystal structure analysis of the CAM-2, the CAM-2 had a layered crystal structure.

As a result of the composition analysis of the CAM-2, in a case of being represented by a compositional formula of Li[Liₓ(Ni_{(1-y-z-w)}Co_{y}Mn_{z}M_{w})₁₋ₓ]O₂, x=0.10, y=0.20, z=0.22, M=Nb, and w=0.01.

### Example 3

### (Production of CAM3)

### [Step of Producing LiMO]

LiMO-1 was obtained by the same method as described above.

### [Step of Forming Coating Layer]

### (Step of Preparing Coating Liquid)

The above-described coating liquid 2 was obtained.

### (Coating Step)

CAM-3 was produced by the same method as in Example 1, except that the coating liquid 2 was used.

### [Evaluation of CAM-3]

The CAM-3 included a coating layer covering at least a part of the surface of the core particle consisting of the LiMO. The coating layer had an oxide containing Nb.

In the CAM-3, a BET specific surface area was 1.01 m²/g, a substance amount of Nb was 1.2×10⁻⁴ mol/m², a standard deviation of the compositional ratio of Nb was 4.8, and a surface presence rate of Nb was 71%.

As a result of the crystal structure analysis of the CAM-3, the CAM-3 had a layered crystal structure.

As a result of the composition analysis of the CAM-3, in a case of being represented by a compositional formula of Li[Liₓ(Ni_{(1-y-z-w)}Co_{y}Mn_{z}M_{w})₁₋ₓ]O₂, x=0.10, y=0.20, z=0.22, M=Nb, and w=0.01.

### Example 4

### (Production of CAM4)

### [Step of Producing LiMO]

LiMO-1 was obtained by the same method as described above.

### [Step of Forming Coating Layer]

### (Step of Preparing Coating Liquid)

355.89 g of H₂O₂ water having a concentration of 30% by mass, 404.63 g of pure water, and 18.2 g of niobium oxide hydrate Nb₂O₅·nH₂O (niobium oxide manufactured by Mitsuwa Chemicals Co., Ltd.) were mixed with each other. Next, 35.92 g of ammonia water having a concentration of 28% by mass was added thereto, and the mixture was stirred. Furthermore, 5.21 g of LiOH H₂O was added thereto to obtain a coating liquid 4 containing a niobium peroxy complex and lithium.

In the coating liquid 4, a molar concentration of Li was 0.16 mol/kg. In the coating liquid 4, a molar concentration of Nb was 0.17 mol/kg. Since the substance amount of Nb contained in the coating liquid 4 was 0.104 mol, the substance amount of Nb per unit area sprayed was 2.3×10⁻⁴ mol/m².

The substance amount of Nb per unit area sprayed was [0.104÷450], which was calculated by the same calculation method as in Example 1, and was calculated to be 2.3×10⁻⁴ mol/m².

### (Coating Step)

CAM-4 was produced by the same method as in Example 1, except that the coating liquid 4 was used.

### [Evaluation of CAM-4]

The CAM-4 included a coating layer covering at least a part of the surface of the core particle containing the LiMO as a forming material. The coating layer had an oxide containing Nb.

In the CAM-4, a substance amount of Nb was 2.6×10⁻⁴ mol/m², a standard deviation of the compositional ratio of Nb was 5.2, and a surface presence rate of Nb was 86%. It is considered that the reason the obtained substance amount of Nb of the CAM-4 was larger than the substance amount of Nb sprayed is that in the coating step, a part of the LiMO-1 was not sufficiently coated with Nb and adhered to the wall surface of the coating device, and the remaining LiMO-1 particles which flowed in the vessel excessively carried the substance amount of Nb with respect to the charged amount.

As a result of the crystal structure analysis of the CAM-4, the CAM-4 had a layered crystal structure.

As a result of the composition analysis of the CAM-4, in a case of being represented by a compositional formula of Li[Liₓ(Ni_{(1-y-z-w)}Co_{y}Mn_{z}M_{w})₁₋ₓ]O₂, x=0.07, y=0.20, z=0.21, M=Nb, and w=0.02.

### Example 5

### (Production of CAM5)

### [Step of Producing LiMO]

LiMO-2 was obtained by the same method as in Example 1, except that the nickel-cobalt-manganese composite hydroxide 1 was changed to a nickel-cobalt-manganese composite hydroxide 2 having Ni/Co/Mn=60/20/20 and D50 of 5 μm to 6 μm, manufactured by GUANGDONG KINLONG INDUSTRY CO., LTD.

### (Evaluation of LiMO-2)

A BET specific surface area of the LiMO-2 was 0.43 m²/g.

### [Step of Forming Coating Layer]

### (Step of Preparing Coating Liquid)

8.21 g of hydrogen diammonium phosphate ((NH₄)₂HPO₄) was added to 337.78 g of pure water, and the mixture was stirred for 2 hours to obtain a coating liquid 5.

In the coating liquid 5, a molar concentration of P was 0.18 mol/kg. Since the substance amount of P contained in the coating liquid 5 was 0.062 mol, the substance amount of P per unit area sprayed was 2.9×10⁻⁴ mol/m².

A calculation method of the substance amount of P per unit area sprayed was as follows.

Since the specific surface area of the LiMO-2 was 0.43 m²/g and the charged amount thereof was 500 g, the total surface area of the LiMO-2 was 215 m² obtained by the product (0.43×500).

The substance amount of P per unit area sprayed was [0.062÷215], which was calculated to be 2.9×10⁻⁴ mol/m² from the total surface area of P contained in the above-described coating liquid 1 and the LiMO-2.

### (Coating Step)

CAM-5 was produced by the same method as in Example 1, except that the coating liquid 5 and the LiMO-2 were used.

### [Evaluation of CAM-5]

The CAM-5 included a coating layer covering at least a part of the surface of the core particle consisting of the LiMO. The coating layer had an oxide containing P.

In the CAM-5, a BET specific surface area was 0.51 m²/g, a substance amount of P was 2.6×10⁻⁴ mol/m², a standard deviation of the compositional ratio of P was 4.7, and a surface presence rate of P was 70%.

As a result of the crystal structure analysis of the CAM-5, the CAM-5 had a layered crystal structure.

As a result of the composition analysis of the CAM-5, in a case of being represented by a compositional formula of Li[Liₓ(Ni_{(1-y-z-w)}Co_{y}Mn_{z}M_{w})₁₋ₓ]O₂, x=0.07, y=0.20, z=0.21, M=P, and w=0.01.

### Comparative Example 1

### (Production of CAM-11)

### [Step of Producing LiMO]

LiMO-11 was obtained by the same method as in Example 1, except that the nickel-cobalt-manganese complex hydroxide 1 was changed to a nickel-cobalt-manganese complex hydroxide 2 having Ni/Co/Mn=60/20/20 and D50 of 3 μm to 4 μm, manufactured by GUANGDONG KINLONG INDUSTRY CO., LTD., the lithium hydroxide monohydrate powder was weighed and mixed in a proportion of Li/(Ni+Co+Mn)=1.05, and the secondary calcining temperature was changed to 820° C.

A BET specific surface area of the LiMO-11 was 0.78 m²/g.

### [Step of Forming Coating Layer]

### (Step of Preparing Coating Liquid)

28.52 g of pentaethoxy niobium and 4.75 g of ethoxy lithium were added to 385.12 g of anhydrous ethanol in an argon atmosphere glove box, and the mixture was stirred for 2 hours to obtain a coating liquid 11.

In the coating liquid 11, a molar concentration of Li was 0.21 mol/kg. In the coating liquid 11, a molar concentration of Nb was 0.21 mol/kg. Since the substance amount of Nb contained in the coating liquid 11 was 0.090 mol, the substance amount of Nb per unit area sprayed was 2.3×10⁻⁴ mol/m².

A calculation method of the substance amount of Nb per unit area sprayed was as follows.

Since the specific surface area of the LiMO-11 was 0.78 m²/g and the charged amount thereof was 500 g, the total surface area of the LiMO-11 was 390 m² obtained by the product (0.78×500).

The substance amount of Nb per unit area sprayed was [0.090÷390], which was calculated to be 2.3×10⁻⁴ mol/m² from the total surface area of Nb contained in the above-described coating liquid 11 and the LiMO-11.

### (Coating Step)

A roll-to-roll flow coating device (MP-01, manufactured by Powrex Corp.) was used in the coating step. 500 g of the powder of the LiMO-11 was subjected to a pre-treatment of drying at 120° C. for 10 hours in a vacuum atmosphere.

Thereafter, the surface of the LiMO-11 was coated with the coating liquid 11 under the following conditions.
Introduction air: air (relative humidity: 50%)
Air supply volume: 0.23 m³/min
Air temperature: 200° C.
Coating liquid flow rate: 3.0 g/min
Spray air flow rate: 50 NL/min

### [Evaluation of CAM-11]

The CAM-11 included a coating layer covering at least a part of the surface of the core particle containing the LiMO as a forming material. The coating layer had an oxide containing Nb.

In the CAM-11, a BET specific surface area was 0.88 m²/g, a substance amount of Nb was 1.7×10⁻⁴ mol/m², a standard deviation of the compositional ratio of Nb was 8.3, and a surface presence rate of Nb was 89%.

As a result of the crystal structure analysis of the CAM-11, the CAM-11 had a layered crystal structure.

As a result of the composition analysis of the CAM-11, in a case of being represented by a compositional formula of Li[Liₓ(Ni_{(1-y-z-w)}Co_{y}Mn_{z}M_{w})₁₋ₓ]O₂, x=0.05, y=0.20, z=0.20, M=Nb, and w=0.02.

In the CAM-11, since the introduced air was atmospheric air (humidity: 50%), the moisture was adsorbed on the surface of the LiMO-11 during flowing, and the spray air flow rate was 50 NL/min, it is considered that peeling of element A carried on the LiMO-11 occurred, and the carrying efficiency of the element A was significantly low, and the standard deviation was also increased.

### Comparative Example 2

### (Production of CAM-12)

### [Step of Producing LiMO]

LiMO-1 was obtained by the same method as described above.

### [Step of Forming Coating Layer]

### (Step of Preparing Coating Liquid)

461.49 g of H₂O₂ water having a concentration of 30% by mass, 523.86 g of pure water, and 23.43 g of niobium oxide hydrate Nb₂O₅·nH₂O (niobium oxide manufactured by Mitsuwa Chemicals Co., Ltd.) were mixed with each other. Next, 46.66 g of ammonia water having a concentration of 28% by mass was added thereto, and the mixture was stirred. Furthermore, 6.7 g of LiOH H₂O was added thereto to obtain a coating liquid 12 containing a niobium peroxy complex and lithium.

In the coating liquid 12, a molar concentration of Li was 0.17 mol/kg. In the coating liquid 8, a molar concentration of Nb was 0.17 mol/kg. Since the substance amount of Nb contained in the coating liquid 12 was 0.134 mol, the substance amount of Nb per unit area sprayed was 3.0×10⁻⁴ mol/m².

A calculation method of the substance amount of Nb per unit area sprayed was as follows.

Since the specific surface area of the LiMO-1 was 0.90 m²/g and the charged amount thereof was 500 g, the total specific surface area of the LiMO-1 was 450 m² obtained by the product (0.90×500).

The substance amount of Nb per unit area sprayed was [0.134÷450], which was calculated to be 3.0×10⁻⁴ mol/m² from the total surface area of Nb contained in the above-described coating liquid 12 and the LiMO-1.

### (Coating Step)

CAM-12 was produced by the same method as in Example 1, except that the coating liquid 12 was used.

### [Evaluation of CAM-12]

The CAM-12 included a coating layer covering at least a part of the surface of the core particle consisting of the LiMO. The coating layer had an oxide containing Nb.

In the CAM-12, a substance amount of Nb was 3.6×10⁻⁴ mol/m², a standard deviation of the compositional ratio of Nb was 7.2, and a surface presence rate of Nb was 89%.

As a result of the crystal structure analysis of the CAM-12, the CAM-12 had a layered crystal structure.

As a result of the composition analysis of the CAM-12, in a case of being represented by a compositional formula of Li[Liₓ(Ni_{(1-y-z-w)}Co_{y}Mn_{z}M_{w})₁₋ₓ]O₂, x=0.06, y=0.20, z=0.21, M=Nb, and w=0.03.

The reason the obtained substance amount of Nb in the CAM-12 was larger than the substance amount of Nb sprayed is considered to be the same as in Example 4.

### Comparative Example 3

### (Production of CAM-13)

### [Step of Producing LiMO]

LiMO-1 was obtained by the same method as described above.

### [Step of Forming Coating Layer]

### (Step of Preparing Coating Liquid)

88.76 g of H₂O₂ water having a concentration of 30% by mass, 100.72 g of pure water, and 4.51 g of niobium oxide hydrate Nb₂O₅·3H₂O (niobium oxide manufactured by Mitsuwa Chemicals Co., Ltd.) were mixed with each other. Next, 8.96 g of ammonia water having a concentration of 28% by mass was added thereto, and the mixture was stirred. Furthermore, 1.29 g of LiOH H₂O was added thereto to obtain a coating liquid 13 containing a niobium peroxy complex and lithium.

In the coating liquid 13, a molar concentration of Li was 0.16 mol/kg. In the coating liquid 9, a molar concentration of Nb was 0.16 mol/kg. Since the substance amount of Nb contained in the coating liquid 13 was 0.026 mol, the substance amount of Nb per unit area sprayed was 0.6×10⁻⁴ mol/m².

A calculation method of the substance amount of Nb per unit area sprayed was as follows.

Since the specific surface area of the LiMO-1 was 0.90 m²/g and the charged amount thereof was 500 g, the total specific surface area of the LiMO-1 was 450 m² obtained by the product (0.90×500).

The substance amount of Nb per unit area sprayed was [0.026÷450], which was calculated to be 0.6×10⁻⁴ mol/m² from the total surface area of Nb contained in the above-described coating liquid 12 and the LiMO-1.

(Coating step)

CAM-13 was produced by the same method as in Example 1, except that the coating liquid 13 was used.

### [Evaluation of CAM-13]

The CAM-13 included a coating layer covering at least a part of the surface of the core particle consisting of the LiMO. The coating layer had an oxide containing Nb.

In the CAM-13, a substance amount of Nb was 0.6×10⁻⁴ mol/m², a standard deviation of the compositional ratio of Nb was 4.5, and a surface presence rate of Nb was 49%.

As a result of the crystal structure analysis of the CAM-13, the CAM-13 had a layered crystal structure.

As a result of the composition analysis of the CAM-13, in a case of being represented by a compositional formula of Li[Liₓ(Ni_{(1-y-z-w)}Co_{y}Mn_{z}M_{w})₁₋ₓ]O₂, x=0.07, y=0.20, z=0.22, M=Nb, and w=0.005.

Table 4 shows the physical properties of the CAM's of Examples 1 to 5 and Comparative Examples 1 to 3 and the battery evaluation results.

TABLE 4

| | | | Surface | | |
|---|---|---|---|---|---|
| | | Standard | presence | Rate | Rate |
| | Weight of | deviation | rate of | character- | character- |
| | element A | of element | element A | istic of | istic of all- |
| | mol/m² | A | % | liquid LIB | solid state |
| Example 1 | 0.8 × 10⁻⁴ | 6.0 | 62 | Good | Good |
| Example 2 | 1.2 × 10⁻⁴ | 5.7 | 68 | Good | Good |
| Example 3 | 1.2 × 10⁻⁴ | 4.8 | 71 | Good | Good |
| Example 4 | 2.5 × 10⁻⁴ | 5.2 | 86 | Good | Good |
| Example 5 | 2.2 × 10⁻⁴ | 4.7 | 70 | Good | Good |
| Comparative | 1.7 × 10⁻⁴ | 8.3 | 89 | Less good | Less good |
| Example 1 | | | | | |
| Comparative | 3.6 × 10⁻⁴ | 7.2 | 89 | Less good | Good |
| Example 2 | | | | | |
| Comparative | 0.6 × 10⁻⁴ | 4.5 | 49 | Less good | Less good |
| Example 3 | | | | | |

As shown in Table 4, it was found that the present invention was useful.

In a case where the coating layer satisfies the present embodiment, that is, in a case where the coating layer is present on the surface of the LiMO in an appropriate amount and with variation, the coating layer has appropriate electron conductivity while maintaining lithium-ion conductivity, and effectively acts as a protective layer, so that it is considered that the rate characteristics can be improved.

### REFERENCE SIGNS LIST

1: Separator
3: Anode
4: Electrode group
5: Battery can
6: Electrolytic solution
7: Top insulator
8: Sealing body
10: Lithium secondary battery
21: Cathode lead
100: Laminate
110: Cathode
111: Cathode active material layer
112: Cathode current collector
113: External terminal
120: Anode
121: Anode active material layer
122: Anode current collector
123: External terminal
130: Solid electrolyte layer
200: Exterior body
200a: Opening portion
1000: Solid lithium secondary battery

1. A cathode active material powder for lithium secondary batteries, comprising:
a core particle consisting of a lithium metal composite oxide; and
a coating layer coating at least a part of the core particle,
wherein the coating layer contains an oxide containing at least one element A selected from the group consisting of Nb, Ta, Ti, Al, B, P, W, Zr, La, and Ge, and
the following (1) and (2) are satisfied,
(1) a substance amount of the element A per unit area, which is calculated from analysis results by inductively coupled plasma mass spectrometry and a nitrogen adsorption BET method, is 3.0×10⁻⁴ mol/m² or less, and
(2) a standard deviation of a compositional ratio of the element A to a total number of atoms in the cathode active material powder for lithium secondary batteries, which is calculated from a value obtained from an SEM-EDX analysis result, is 4.6 or more and 8.2 or less.

2. The cathode active material powder for lithium secondary batteries according to claim 1,
wherein the cathode active material powder is used by being brought into contact with a solid electrolyte.

3. The cathode active material powder for lithium secondary batteries according to claim 2,
wherein the cathode active material powder is used in a solid lithium secondary battery containing a sulfide solid electrolyte.

4. The cathode active material powder for lithium secondary batteries according to claim 1,
wherein a surface presence rate of the element A, which is calculated from an XPS analysis result of the cathode active material powder for lithium secondary batteries, is 50% or more.

5. The cathode active material powder for lithium secondary batteries according to claim 1,
wherein the element A is Nb or P.

6. The cathode active material powder for lithium secondary batteries according to claim 1,
wherein the cathode active material powder has a layered crystal structure.

7. The cathode active material powder for lithium secondary batteries according to claim 1,
wherein the following compositional formula (I) is satisfied,
Li[Liₓ(Ni_{(1-y-z-w)}Co_{y}Mn_{z}M_{w})₁₋ₓ]O₂ (I)
(where, M is at least one element selected from the group consisting of Fe, Cu, Mg, Al, W, B, P, Mo, Zn, Sn, Zr, Ga, La, Ti, Nb, and V, and −0.10≤x≤0.30, 0≤y≤0.40, 0≤z≤0.40, and 0<w≤0.10 are satisfied).

8. The cathode active material powder for lithium secondary batteries according to claim 7,
wherein, in the compositional formula (I), 0.50≤1−y−z−w≤0.95 and 0<y≤0.30 are satisfied.

9. An electrode comprising:
the cathode active material powder for lithium secondary batteries according to claim 1.

10. The electrode according to claim 9, further comprising:
a solid electrolyte.

11. A solid lithium secondary battery, comprising:
a cathode;
an anode; and
a solid electrolyte layer interposed between the cathode and the anode,
wherein the solid electrolyte layer contains a first solid electrolyte,
the cathode includes a cathode active material layer in contact with the solid electrolyte layer, and a current collector on which the cathode active material layer is laminated, and
the cathode active material layer contains the cathode active material powder for lithium secondary batteries according to claim 1.

12. The solid lithium secondary battery according to claim 11,
wherein the cathode active material layer further contains a second solid electrolyte.

13. The solid lithium secondary battery according to claim 12,
wherein the first solid electrolyte and the second solid electrolyte are the same material.

14. The solid lithium secondary battery according to claim 11,
wherein the first solid electrolyte is a sulfide solid electrolyte.

15. The cathode active material powder for lithium secondary batteries according to claim 2,
wherein a surface presence rate of the element A, which is calculated from an XPS analysis result of the cathode active material powder for lithium secondary batteries, is 50% or more.

16. The cathode active material powder for lithium secondary batteries according to claim 2,
wherein the element A is Nb or P.

17. The cathode active material powder for lithium secondary batteries according to claim 2,
wherein the cathode active material powder has a layered crystal structure.

18. The cathode active material powder for lithium secondary batteries according to claim 2,
wherein the following compositional formula (I) is satisfied,
Li[Liₓ(Ni_{(1-y-z-w)}Co_{y}Mn_{z}M_{w})₁₋ₓ]O₂ (I)
(where, M is at least one element selected from the group consisting of Fe, Cu, Mg, Al, W, B, P, Mo, Zn, Sn, Zr, Ga, La, Ti, Nb, and V, and −0.10≤x≤0.30, 0≤y≤0.40, 0≤z≤0.40, and 0<w≤0.10 are satisfied).

19. An electrode comprising:
the cathode active material powder for lithium secondary batteries according to claim 2.

20. The solid lithium secondary battery according to claim 12,
wherein the first solid electrolyte is a sulfide solid electrolyte.
